(19) United States
(12) Patent Application Publication
(10) Pub. No.: US 2014/0337250 A1
(43) Pub. Date: Nov. 13, 2014

(54) INFORMATION PROVIDING SYSTEM, SERVER DEVICE, RECORDING MEDIUM, AND CONTROL METHOD

(71) Applicant: KONAMI DIGITAL ENTERTAINMENT CO., LTD., Tokyo (JP)

(72) Inventors: Shigenobu MATSUYAMA, Tokyo (JP); Tomoko HABARA, Tokyo (JP); Harue KODACHI, Tokyo (JP); Kei SUGANO, Tokyo (JP)

(73) Assignee: KONAMI DIGITAL ENTERTAINMENT CO., LTD., Tokyo (JP)

(21) Appl. No.: 14/341,894

(22) Filed: Jul. 28, 2014

Related U.S. Application Data
(63) Continuation-in-part of application No. PCT/JP2012/082880, filed on Dec. 19, 2012.

(30) Foreign Application Priority Data
Feb. 2, 2012 (JP) 2012-021378

(51) Int. Cl. G06Q 30/02

(52) U.S. Cl. CPC G06Q 30/0282
USPC 705/347

(57) ABSTRACT

An information providing system having a server device connected to an external server device, which accumulates review management information, including review information indicating a review of a piece of content by a first user and first identification information that corresponds to the first user and history information that indicates a service usage history of the first user and provides a first service that includes a browsing service making the review of the piece of content by the first user browsable. The server device provides a second service to each second user; and a terminal device that the second user operates. Upon receiving a request from the terminal device, the server device acquires and sends, to the terminal device, review management information regarding a piece of content based on a first service usage history of the second user. The terminal device controls a screen display using the received review management information.

### CROSS REFERENCE TO RELATED APPLICATIONS

This application is a continuation-in-part application of PCT Application No. PCT/JP2012/082880, filed Dec. 19, 2012, and claiming the benefit of priority from Japanese Patent Application No. 2012-021378, the entire contents of all of which are incorporated herein by reference.

### BACKGROUND OF THE INVENTION

1. Field of the Invention

The present invention relates to a technology in which information related to a review of a piece of content is acquired from an external server to present to a user.

2. Description of Related Art

A technology in which rating comments (reviews) posted for various pieces of content (music CDs, movie DVDs, books, gaming software, restaurants, etc.) are presented to users is known (e.g., Patent Document 1). In a commonly used configuration in the technology above, information (e.g., a title and a description) of a piece of content that a user has requested is displayed on a screen along with reviews of the piece of content by other users.

### CITATION LIST

### Patent Document

Patent Document 1: JP-A-2001-243310

### SUMMARY OF THE INVENTION

In the technology in which reviews of a piece of content are displayed based on a request from a user, only reviews of the requested piece of content are presented to the user. Thus, if the requested piece of content is not what the user actually likes, the reviews of the piece of content are likely to be of little value to the user.

In the light of the situation above, an object of the present invention is to provide an information providing system, a server device, a recording medium, and a control method, each of which can provide review information regarding a piece of content that is more suited to users' liking.

An information providing system according to the present invention includes: a server device that is communicably connected to an external server device, the external server device accumulating review management information that includes review information that indicates a review of a piece of content by a first user and first identification information that corresponds to the first user, the external server device associating and storing the first identification information and history information that indicates a service usage history of the first user, the external server device providing a first service that includes a browsing service that makes the review of the piece of content by the first user browsable, the server device providing a second service to each second user; and a terminal device that the second user operates. The server device includes: an acquisition unit configured to, upon receiving a request from the terminal device of the second user, retrieve the first identification information corresponding to second identification information of the second user from an identification information storing unit that associates and stores first identification information corresponding to a user and second identification information corresponding to the same user so as to acquire, using the retrieved first identification information, review management information regarding, from among pieces of content managed by the external server device, at least one of a piece of content based on a first service usage history of the second user in the external server device and a piece of content based on attribute information of the piece of content; and a response unit configured to send the review management information acquired by the acquisition unit to the terminal device. The terminal device includes: a display unit; a receiving unit configured to receive the review management information from the server device; and a display control unit configured to control a screen display on the display unit based on the review management information received by the receiving unit.

In another aspect, the present invention is a server device configured to communicate with an external server device, the external server device accumulating review management information that includes review information that indicates a review of a piece of content by a first user and first identification information that corresponds to the first user, associating and storing the first identification information and history information that indicates a service usage history of the first user, and providing a first service that includes a browsing service that makes the review of the piece of content by the first user browsable. The server device is used in an information providing system that includes a terminal device, the terminal device being operated by a second user and displaying the review information. The server device provides a second service to each second user. The server device includes: an acquisition unit configured to, upon receiving a request from the terminal device of the second user, retrieve the first identification information corresponding to second identification information of the second user from an identification information storing unit that associates and stores first identification information corresponding to a user and second identification information corresponding to the same user so as to acquire, using the retrieved first identification information, review management information regarding, from among pieces of content managed by the external server device, at least one of a piece of content based on a first service usage history of the second user in the external server device and a piece of content based on attribute information of the piece of content; and a response unit configured to send the review management information acquired by the acquisition unit to the terminal device.

In another aspect, the present invention is a non-transitory recording medium storing a computer program that is executed in a processor in a computer. The computer communicates with an external server device, the external server device accumulating review management information that includes review information that indicates a review of a piece of content by a first user and first identification information that corresponds to the first user, associating and storing the first identification information and history information that indicates a service usage history of the first user, and providing a first service that includes a browsing service that makes the review of the piece of content by the first user browsable. The computer is used in an information providing system that includes a terminal device that is operated by a second user and displays the review information. The computer provides a second service to each second user. The computer program makes the computer function as: an acquisition unit configured to, upon receiving a request from the terminal device of the second user, retrieve the first identification information corresponding to second identification information of the second user from an identification information storing unit that associates and stores first identification information corresponding to a user and second identification information corresponding to the same user so as to acquire, using the retrieved first identification information, review management information regarding, from among pieces of content managed by the external server device, at least one of a piece of content based on a first service usage history of the second user in the external server device and a piece of content based on attribute information of the piece of content; and a response unit configured to send the review management information acquired by the acquisition unit to the terminal device.

In another aspect, the present invention is a control method for a server device that communicates with an external server device, the external server device accumulating review management information that includes review information that indicates a review of a piece of content by a first user and first identification information that corresponds to the first user, associating and storing the first identification information and history information that indicates a service usage history of the first user, and providing a first service that includes a browsing service that makes the review of the piece of content by the first user browsable. The server device is used in an information providing system that includes a terminal device that is operated by a second user and displays the review information. The server device provides a second service to each second user. The control method includes: in the server device, retrieving, upon receiving a request from the terminal device of the second user, the first identification information corresponding to second identification information of the second user from an identification information storing unit that associates and stores first identification information corresponding to a user and second identification information corresponding to the same user, acquiring, using the retrieved first identification information, review management information regarding, from among pieces of content managed by the external server device, at least one of a piece of content based on a first service usage history of the second user in the external server device and a piece of content based on attribute information of the piece of content, and sending the acquired review management information to the terminal device.

In another aspect, the present invention is another control method for an information providing system that includes: a server device that is communicably connected to an external server device, the external server device accumulating review management information that includes review information that indicates a review of a piece of content by a first user and first identification information that corresponds to the first user, associating and storing the first identification information and history information that indicates a service usage history of the first user, and providing a first service that includes a browsing service that makes the review of the piece of content by the first user browsable, the server device providing a second service to each second user; and a terminal device that the second user operates. The control method includes: in the server device, retrieving, upon receiving a request from the terminal device of the second user, the first identification information corresponding to second identification information of the second user from an identification information storing unit that associates and stores first identification information corresponding to a user and second identification information corresponding to the same user, acquiring, using the retrieved first identification information, review management information regarding, from among pieces of content managed by the external server device, at least one of a piece of content based on a first service usage history of the second user in the external server device and a piece of content based on attribute information of the piece of content, and sending the acquired review management information to the terminal device; and in the terminal device, receiving the review management information from the server device, and controlling a screen display of the terminal device based on the review management information received from the server device.

### BRIEF DESCRIPTION OF DRAWINGS

FIG. 1 is a block diagram illustrating an information providing system according to an embodiment of the present invention;

FIG. 2 is a block diagram illustrating a physical configuration of a terminal device;

FIG. 3 is a block diagram illustrating a physical configuration of a server device;

FIG. 4 is a block diagram illustrating a physical configuration of an external server device;

FIG. 5 is a block diagram illustrating a functional configuration of the terminal device, the server device, and the external server device;

FIG. 6 is a diagram illustrating a configuration of a content information table in the external server device;

FIG. 7 is a diagram illustrating a configuration of a first user information table in the external server device;

FIG. 8 is a diagram illustrating a configuration of a review management information table in the external server device;

FIG. 9 is a diagram illustrating a configuration of a second user information table in the server device;

FIG. 10 is a diagram illustrating a configuration of an identification information table in the server device;

FIG. 11 is a diagram illustrating a configuration of a point information table in the server device;

FIG. 12 shows an operation sequence of OAuth authentication;

FIG. 13 is an illustration according to an example of a registration screen;

FIG. 14 is an illustration according to an example of an authentication screen;

FIG. 15 shows an outline of an operation sequence to acquire and display a timeline;

FIG. 16 shows a detailed operation sequence of a review management information acquisition operation performed by a first acquisition unit of the server device;

FIG. 17 shows a detailed operation sequence of a review management information acquisition operation performed by a second acquisition unit of the server device;

FIG. 18 shows a detailed operation sequence of a review management information acquisition operation performed by a third acquisition unit of the server device;

FIG. 19 is an illustration according to an example of a timeline screen;

FIG. 20 shows an operation flow for a display process performed by the terminal device;

FIG. 21 is an illustration according to an example of a review thread detail screen;

FIG. 22 is an illustration according to an example of the review thread detail screen;

FIG. 23 shows a more detailed operation sequence of the operation sequence shown in FIG. 15;

FIG. 24 shows a more detailed operation sequence of the operation sequence shown in FIG. 15;

FIG. 25 is an illustration according to an example of a default user image;

FIG. 26 is a diagram showing an example of an individual review display field and a user image when a rating value is “5”;

FIG. 27 is a diagram showing an example of the individual review display field and the user image when the rating value is “3”;

FIG. 28 is a diagram showing an example of the individual review display field and the user image when the rating value is “1”;

FIG. 29 shows an operation sequence of review posting through the server device;

FIG. 30 is an illustration according to an example of the timeline screen;

FIG. 31 is a diagram illustrating a configuration of a content information table according to a modification;

FIG. 32 is a diagram illustrating a second user information table according to a modification;

FIG. 33 is an illustration according to an example of a timeline screen according to a modification; and

FIG. 34 is a diagram illustrating a manner in which a user image according to a modification is displayed.

### DETAILED DESCRIPTION OF THE INVENTION

### 1. Configuration of Information Providing System

### 1-1. Overview of Configuration

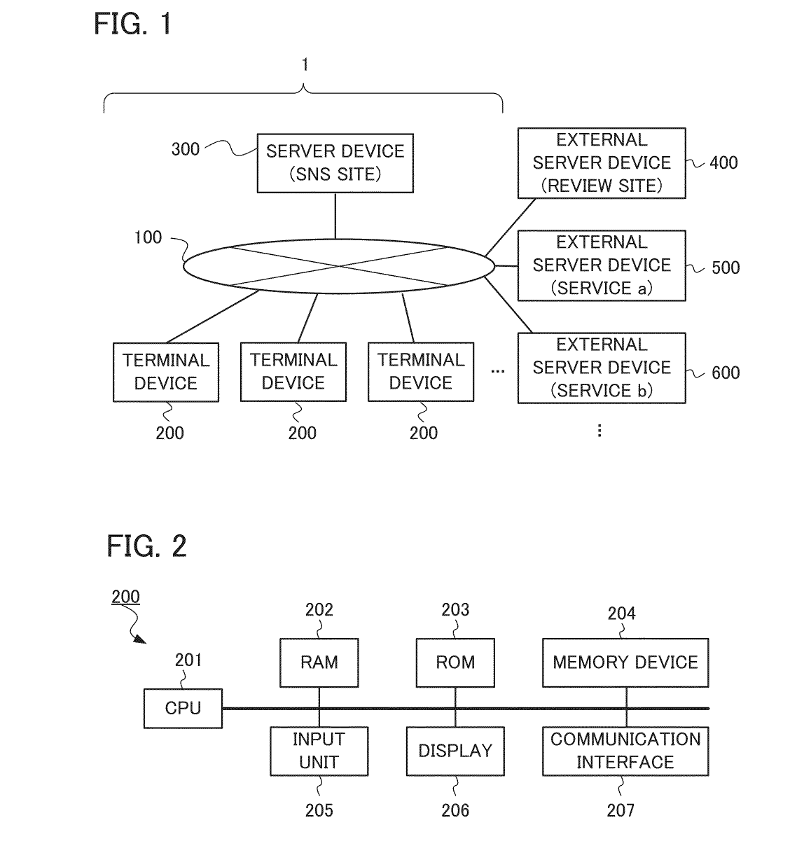

FIG. 1 shows a block diagram illustrating an information providing system 1 according to a first embodiment of the present invention. The information providing system 1 includes a terminal device 200 and a server device 300 that are interconnected through a network 100 (e.g., the Internet). The server device 300 is communicably connected to each of external server devices (400, 500, 600, etc.) through the network 100. The server device 300 provides each user with a Social Networking Service (SNS) site that allows communication (i.e., an exchange of message management information between its users; e.g., a message board, mail, and chat) between its users. A user of the server device 300 (the SNS site) uses the SNS site by operating the terminal devices 200.

The SNS site provided by the server device 300 also functions as a portal site that provides the user with information acquired from the external server devices (400, 500, 600, etc.). Among the external server devices (400, 500, 600, etc.), the external server device 400 provides each of its users with a browsing service (a review site) that enables the user to browse reviews of various pieces of registered content (e.g., music CDs, movies, books, and games). The external server device 400 may have, in addition to a function as a review site, a function to sell the various pieces of content to each user. The various pieces of content can be sold to the user of the external server device 400 as a commodity (e.g., a music CD) or as a service (e.g., streaming delivery of movies). Moreover, if the external server device 400 provides reviews of restaurants or accommodations, the external server device 400 can also provide the user with a reservation service to make reservations at restaurants or for accommodations. Providing the reservation service described here is also a form of the sales of a piece of content described above.

Hereinafter, for simplicity, a user of the external server device 400 (the review site) may be referred to as a “first user”, and a user of the server device 300 (the SNS site) may be referred to as a “second user”.

### 1-2. Physical Configuration

FIG. 2 shows a block diagram illustrating a physical configuration of the terminal device 200. The terminal device 200 includes a central processing unit (CPU) 201 that controls the entire device, a random access memory (RAM) 202 that functions as a work area for the CPU 201, a read only memory (ROM) 203 that stores a boot program, a memory device 204 that stores programs and data and are rewritable, an input unit 205 that includes input devices such as a touchscreen, a display 206 that displays images, and a communication interface 207 that communicates with an external device through the network 100. The terminal device 200 may be, for instance, a mobile phone such as a smartphone or a personal computer.

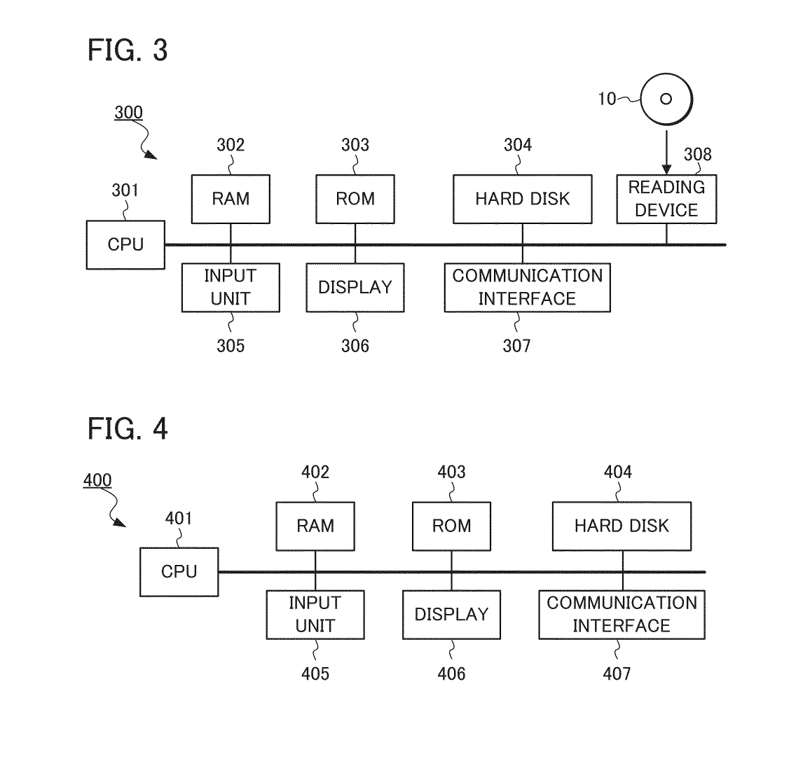

FIG. 3 shows a block diagram illustrating a physical configuration of the server device 300. The server device 300 includes a CPU 301 that controls the entire device, a RAM 302 that functions as a work area for the CPU 301, a ROM 303 that stores a boot program, a hard disk 304 that stores programs and data, an input unit 305 that includes input devices such as a keyboard and a mouse, a display 306 that displays images, a communication interface 307 that communicates with an external device through the network 100, and a reading device 308 that can read an information recording medium such as a compact disk.

FIG. 4 shows a block diagram illustrating a physical configuration of the external server device 400. The external server device 400 includes a CPU 401 that controls the entire device, a RAM 402 that functions as a work area for the CPU 401, a ROM 403 that stores a boot program, a hard disk 404 that stores programs and data, an input unit 405 that includes input devices such as a keyboard and a mouse, a display 406 that displays images, and a communication interface 407 that communicates with an external device through the network 100. Other external server devices (500, 600, etc.) have physical configurations similar to the physical configuration of the external server device 400 described above.

### 1-3. Functional Configuration

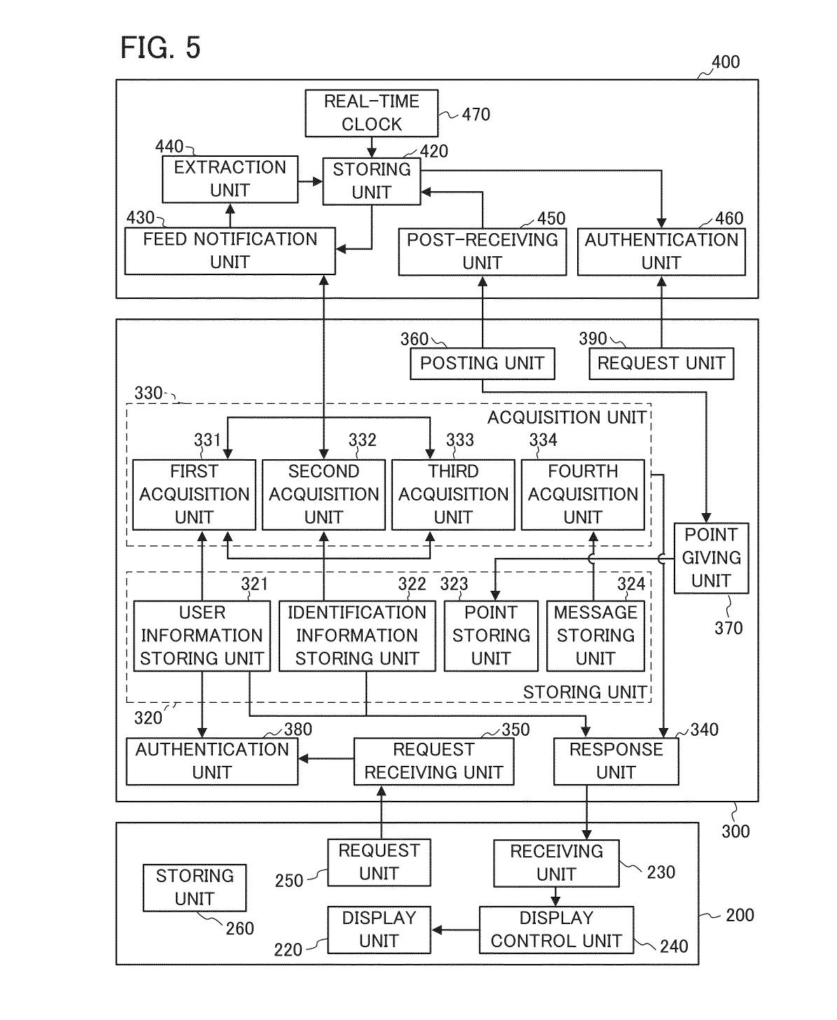

FIG. 5 shows a diagram illustrating a functional configuration of the terminal device 200, the server device 300, and the external server device 400 and a general relationship between elements of them.

### 1-3-1. Configuration of External Server Device (Review Site)

The external server device 400 includes a storing unit 420, a feed notification unit 430, an extraction unit 440, a post-receiving unit 450, an authentication unit 460, and a real-time clock (RTC) 470. The feed notification unit 430, the extraction unit 440, the post-receiving unit 450, and the authentication unit 460 are a functional block performed by the CPU 401, which is in the external server device 400, executing a computer program stored in the ROM 403 or in the hard disk 404 and functioning according to the computer program. The storing unit 420 includes the RAM 402, the ROM 403, and the hard disk 404 and is a storage area that includes a rewritable area. The storing unit 420 may be placed in a device other than the external server device 400. In this case, the external server device 400 transmits and receives information from the storing unit 420 through the network 100. That is, the storing unit 420 is not an essential element of the external server device 400.

The storing unit 420 accumulates (stores) review management information that includes review information that indicates a review of various pieces of content by a first user and a first account that can uniquely identify the first user in the external server device 400. Moreover, the storing unit 420 associates and stores the first account and usage history information that indicates a service usage history of the first user corresponding to the first account. Furthermore, the storing unit 420 stores favorites information associated with the first account. The first user registers the favorites information with the external server device 400 (the storing unit 420) beforehand using the terminal device 200. Each kind of information above is described later in detail.

### 1-3-2. Configuration of Server Device

The server device 300 includes a storing unit 320, an acquisition unit 330, a response unit 340, a request receiving unit 350, a posting unit 360, a point giving unit 370, an authentication unit 380, and a request unit 390. The storing unit 320 includes a user information storing unit 321, an identification information storing unit 322, a point storing unit 323, and a message storing unit 324. The acquisition unit 330 includes a first acquisition unit 331, a second acquisition unit 332, a third acquisition unit 333 and a fourth acquisition unit 334.

The acquisition unit 330, the response unit 340, the request receiving unit 350, the posting unit 360, the point giving unit 370, the authentication unit 380, and the request unit 390 are a functional block performed by the CPU 301, which is in the server device 300, executing a computer program stored in the ROM 303 or in the hard disk 304 and functioning according to the computer program. The storing unit 320 includes the RAM 302, the ROM 303, and the hard disk 304 and is a storage area that includes a rewritable area. The storing unit 320 may be placed in a device other than the server device 300. In this case, the server device 300 transmits and receives information from the storing unit 320 through the network 100. That is, the storing unit 320 is not an essential element of the server device 300.

Furthermore, for the computer program to be stored in the storing unit 320 (the hard disk 304) of the server device 300, the computer program may be downloaded from a server on the Internet or may be obtained from a personal computer that stores the computer program. The computer program stored in an information recording medium 10 (FIG. 3) may be retrieved by the reading device 308 of the server device 300 to be stored in the storing unit 320 (the hard disk 304). The information recording medium 10 is preferably a non-transitory recording medium.

The user information storing unit 321 of the server device 300 associates and stores user information that includes preference information of the second user and a second account that can uniquely identify the second user in the server device 300. The identification information storing unit 322, when the user (first user) of the external server device 400 and the user (second user) of the server device 300 are the same user, associates and stores the first account of the user and the second account of the user.

The first acquisition unit 331, the second acquisition unit 332, and the third acquisition unit 333 of the server device 300 are an application programming interface (API) that acquires, based on a request received from a request unit 250 of the terminal device 200 described later, review management information stored in the storing unit 420 of the external server device 400 from the feed notification unit 430 of the external server device 400. The fourth acquisition unit 334 is an API that acquires, based on a request from the request unit 250 of the terminal device 200, message management information stored in the message storing unit 324. Operations of each element (331 to 334) in the acquisition unit 330 are described later in detail.

### 1-3-3. Configuration of Terminal Device

The terminal device 200 includes a display unit 220, a receiving unit 230, a display control unit 240, the request unit 250, and a storing unit 260. The receiving unit 230, the display control unit 240, and the request unit 250 are a functional block performed by the CPU 201, which is in the terminal device 200, executing a computer program stored in the ROM 203 or in the memory device 204 and functioning according to the computer program. The display unit 220 includes a display 206. The storing unit 260 includes the RAM 202, the ROM 203, and the memory device 204 and is a storage area that includes a rewritable area.

The receiving unit 230 of the terminal device 200 receives review management information transmitted by the server device 300 (the response unit 340). The display control unit 240 controls, based on the review management information received by the receiving unit 230, a screen display on the display unit 220 (the display 206) to display various kinds of texts and images.

### 1-4. Configuration of Storing Unit

### 1-4-1. Configuration of Storing Unit of External Server Device (Review Site)

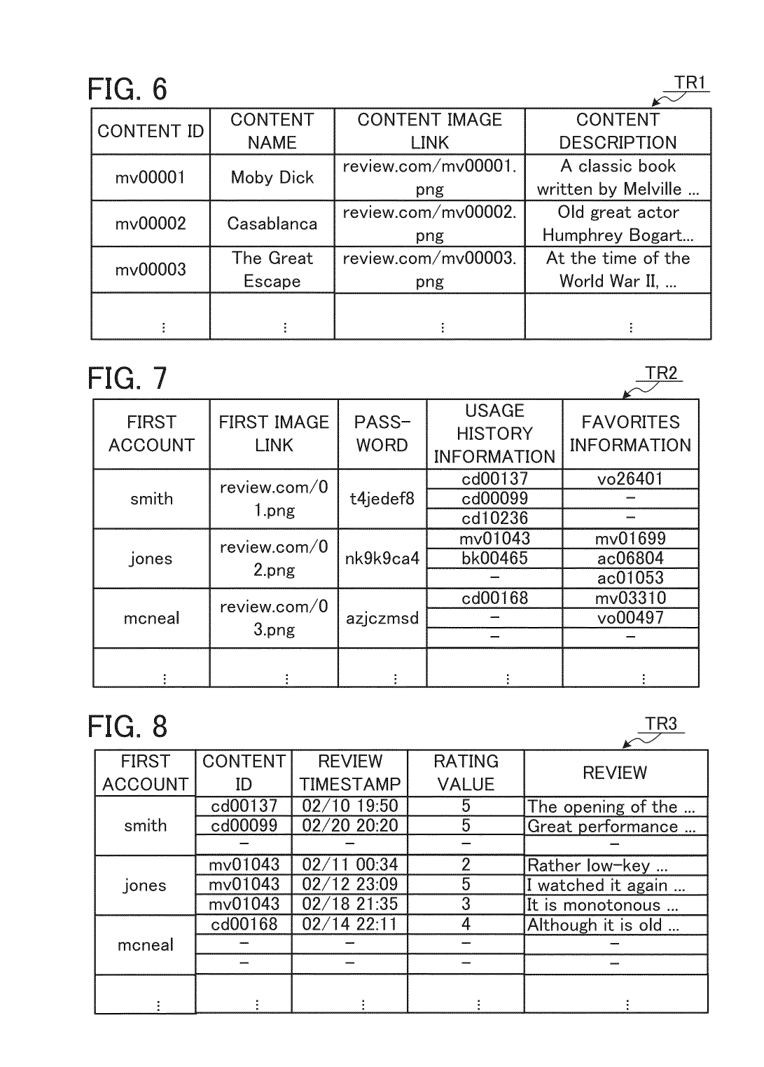

By referring to FIGS. 6 to 8, data stored in the storing unit 420 of the external server device 400 are described in detail. The storing unit 420 stores a content information table TR1 (FIG. 6), a first user information table TR2 (FIG. 7), and a review management information table TR3 (FIG. 8). The above-mentioned tables (TR1, TR2, and TR3) can be configured as a relational database in which tables can be joined to each other to extract data.

As shown in FIG. 6, the content information table TR1 associates and stores a content ID, a content name, a content image link, and a content description. The content ID is an identifier that uniquely identifies a single piece of content. The content name is a name of the piece of content. The content image link is an indicator (e.g., URL) of a location where a content image that corresponds to the piece of content is stored. The content description is a description that describes a piece of content that is identified by the content ID. Each of the content name, the content image link, and the content description is in a one-to-one relationship with the content ID.

A configuration in which the content information table TR1 stores a content image itself, instead of a content image link, can also be used.

As shown in FIG. 7, the first user information table TR2 associates and stores the first account, a first image link, a password, the usage history information, and the favorites information. The first account is as described above. The first image link is an indicator (e.g., URL) of a location where a user image that corresponds to the first user who has posted a review that is managed by the external server device 400. The first image link is in a one-to-one relationship with the first account. The usage history information indicates a usage history in the external server device 400 for the first user corresponding to the first account. For example, the usage history information may indicate a purchase history of a piece of content (a commodity or a service) that the first user has purchased. The usage history information may be indicated by a content ID. At least one usage history corresponds to a single first account. The favorites information indicates a content ID of a piece of content that the first user has registered beforehand with the external server device 400 and in which the first user has an interest. At least one piece of favorites information corresponds to a single first account.

A configuration in which the first user information table TR2 stores a user image itself of a first user, instead of a first image link, can also be used.

As shown in FIG. 8, the review management information table TR3 associates and stores the first account, the content ID, a review timestamp, a rating value, and a review. The review management information table TR3 stores a review and information related to the review, the review being posted for some piece of content by the first user to the external server device. The first account and the content ID are as described above. Since the first user can post a review of each piece among multiple pieces of content, multiple content IDs can correspond to the first user. The review indicates a text of the review that the first user has posted for a piece of content. The review timestamp indicates a time (timestamp) when the first user has posted the review and that is timed by the real-time clock 470 to be stored. The rating value indicates a score that the review-posting first user has given to the piece of content corresponding to the review. The rating value may be, for example, an integer value that takes a higher value with a higher rating and ranges from 1 to 5. The review timestamp and the rating value are respectively in a one-to-one relationship with the review. Since the first user can post multiple reviews for a single piece of content, it is to be understood that based on a combination of the first account, the content ID, and the review timestamp, the review is uniquely identifiable.

### 1-4-2. Configuration of Storing Unit of Server Device

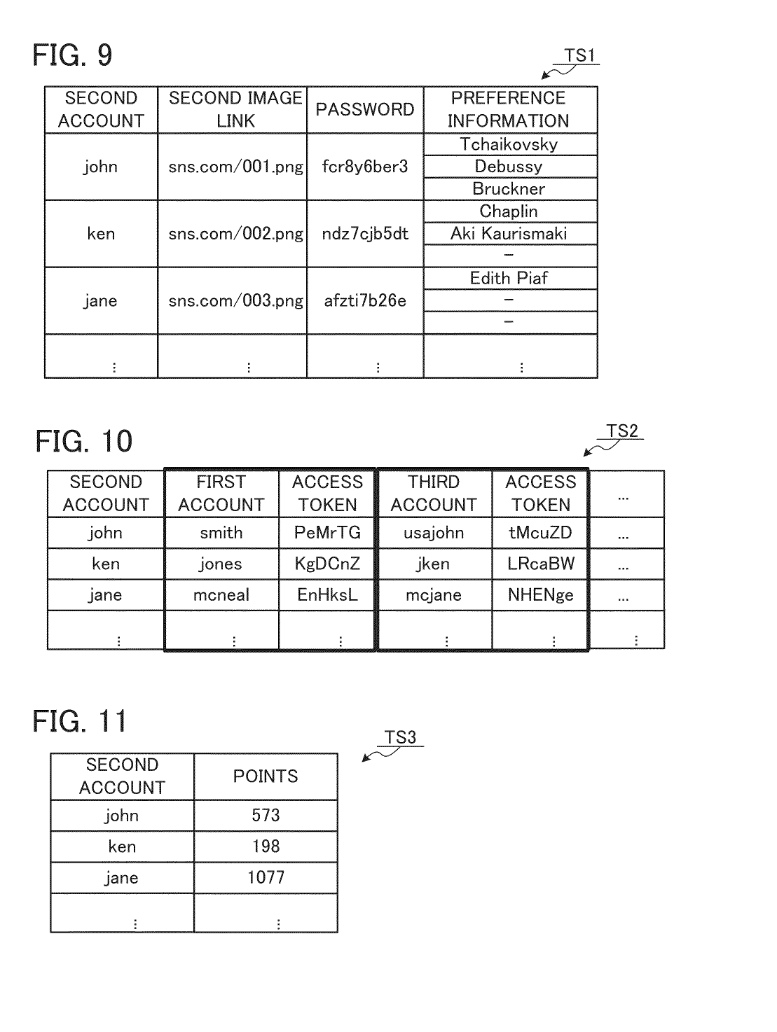

By referring to FIGS. 9 to 11, data stored in the storing unit 320 of the server device 300 are described in detail. The user information storing unit 321 stores a second user information table TS 1 (FIG. 9). The identification information storing unit 322 stores an identification information table TS2 (FIG. 10). The point storing unit 323 stores a point information table TS3 (FIG. 11). The above-mentioned tables (TS1, TS2, and TS3) can be configured as a relational database in which tables can be joined to each other to extract data.

As shown in FIG. 9, the second user information table TS1 associates and stores the second account, a second image link, a password, and the preference information. A row (record) in the second user information table TS1 is generated for each user when a user is registered with the server device 300. The second account, as described above, is an identifier that uniquely identifies the second user in the server device 300. The second image link is an indicator (e.g., URL) of a location where a user image that corresponds to the second user is stored. The second image link is in a one-to-one relationship with the second account. The password is a string of characters that the second user uses to login to the server device 300. The password is in a one-to-one relationship with the second account. The preference information indicates information that is related to an item (e.g., a name of a composer, a name of a film director, etc.) in which the second user has an interest and that the second user has registered beforehand with the server device 300. The preference information is expressed as text data. At least one piece of preference information corresponds to a single second account.

A configuration in which the first user information table TR2 stores a user image itself of a first user, instead of a first image link, can also be used.

As shown in FIG. 10, the identification information table TS2 associates and stores the second account in the server device 300 and account information in the external server devices (400, 500, 600, etc.). The account information includes an account in an external server device and an access token that corresponds to the account. The access token is authentication information that the server device 300 needs in order to access the external server device on behalf of the account (user) corresponding to the access token. An example of an authentication operation by which the server device 300 obtains an access token from an external server device is described later.

As shown in FIG. 11, the point information table TS3 associates and stores the second account and points. A datum in the points is in a one-to-one relationship with the second account. The datum in the points indicates the number of points that the second user of the corresponding second account has gained in the server device 300. The second user can use the gained points in the server device 300 (the SNS site).

### 2. Operations of Information Providing System

### 2-1. Authentication Operation

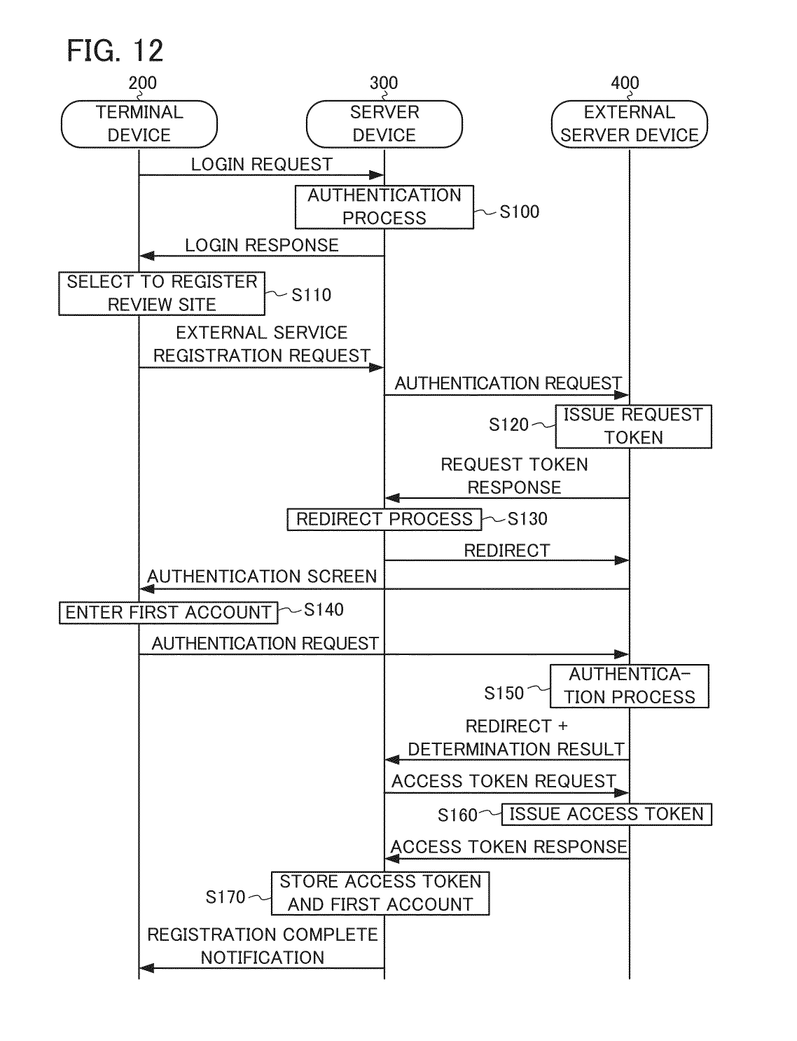

FIG. 12 shows an operation sequence of authentication (OAuth authentication) needed beforehand for the server device 300 (the acquisition unit 330) to acquire review management information from the external server device 400. In an example shown in FIG. 12, a user of the server device 300 selects a review site provided by the external server device 400 as a site to be registered and registers the review site with the server device 300. A similar authentication operation can be performed when the server device 300 (the acquisition unit 330) acquires information from a service provided by other external server devices (500, 600, etc.).

When the second user accesses a login page of the server device 300 (the SNS site) using the terminal device 200, a login screen is displayed on the display 206 (the display unit 220) of the terminal device 200. The login screen includes input fields (input boxes) for a second account and a password. If the second user enters his or her own second account and password and presses a submit button of the input unit 205, the request unit 250 of the terminal device 200 sends a login request that includes the entered second account and the entered password to the server device 300.

When the request receiving unit 350 of the server device 300 receives the login request, the server device 300 performs an authentication process (S100). Specifically, the authentication unit 380 determines whether a combination of the second account and the password entered by the second user is stored in the second user information table TS1. If the condition for determination is satisfied, the authentication unit 380 gives permission for login with the second account, and if the condition is not satisfied, the authentication unit 380 refuses permission for login with the second account. The authentication unit 380 sends a login response that indicates the determination result to the terminal device 200. The example shown in FIG. 12 illustrates a case in which login is permitted.

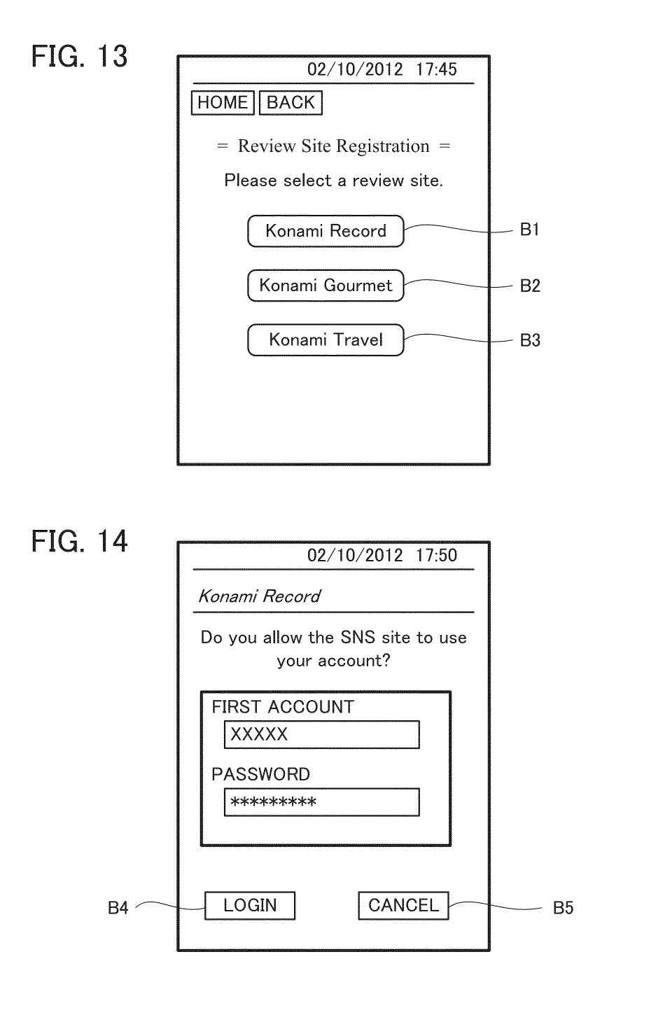

When the second user operates the terminal device 200 to select to register a review site, a registration screen as illustrated in FIG. 13 is displayed on the display 206 (the display unit 220). On the registration screen, selection buttons B1 to B3 that present, to the second user, options for review sites that can be registered with the server device 300 are displayed. When the second user presses the selection button B1 (corresponding to the review site provided by the external server device 400) (S110), the request unit 250 of the terminal device 200 sends an external service registration request to the server device 300, requesting that the review site provided by the external server device 400 be registered with the server device 300.

When the request receiving unit 350 of the server device 300 receives the external service registration request, the request unit 390 sends a request for authentication needed for the server device 300 itself to access the review site (the external server device 400) to the external server device 400. Upon receiving the authentication request, the authentication unit 460 of the external server device 400 issues a request token (S120) to send the request token to the server device 300 as a request token response. After receiving the token response, the server device 300 stores the request token (S130) and redirects the terminal device 200 to an authentication screen page of the external server device 400. The external server device 400 makes the terminal device 200 display an authentication screen.

FIG. 14 illustrates an example of the authentication screen of the external server device 400 to which the terminal device 200 has been redirected. On the authentication screen, input fields (input boxes) for a first account and a password, a login button B4, and a cancel button B5 are displayed. When the user of the terminal device 200 enters the user's own first account and password (S140) and presses the login button B4, the request unit 250 of the terminal device 200 sends an authentication request that includes the entered first account and the entered password to the external server device 400.

Upon receiving the authentication request, the authentication unit 460 of the external server device 400 performs an authentication process (S150). Specifically, the authentication unit 460 determines whether a combination of the first account and the password entered by the user of the terminal device 200 is stored in the first user information table TR2 (whether the user is a legitimate user). Subsequently, the external server device 400 notifies the server device 300 of the determination result and is redirected to a predetermined page of the server device 300.

Upon receiving the determination result indicating that the condition for determination at the authentication process (S150) is satisfied, the server device 300 sends an access token request requesting an access token with access authority to the external server device 400. After receiving the access token request, the external server device 400 issues an access token (S160) based on authentication information of the first account and the like and the authorized request token so as to send the issued access token to the server device 300 as an access token response.

Upon receiving the access token, the server device 300 associates and stores a combination of the first account and the access token in the external server device 400 and the corresponding second account in the server device 300 in the identification information table TS2 (S170). Subsequently, the server device 300 notifies the terminal device 200 of a completion of registration.

### 2-2. Timeline Acquisition Operation

### 2-2-1. Outline of Timeline Operation

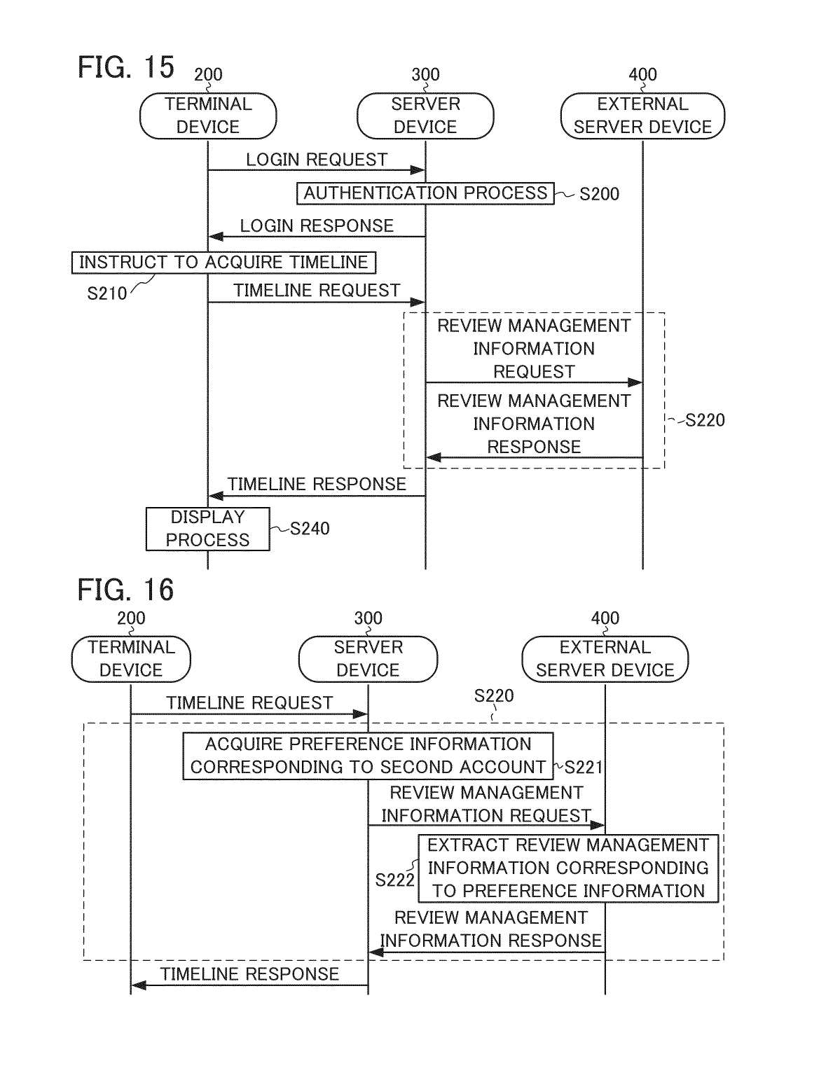

An outline of an operation sequence to acquire and display a timeline is shown in FIG. 15. Since processes for a login request, an authentication process (S200), and a login response are similar to those described above by referring to FIG. 12, description for these processes is omitted. A timeline represents a collection of information (reviews, information from other external server devices, messages within the SNS site, etc.) for a user and is arranged in chronological order. A timeline according to the present embodiment can include reviews and other information. For simplicity, however, a configuration in which only reviews (a review thread Th) are displayed is described first.

When the second user instructs the terminal device 200 to acquire a timeline for the SNS site (S210), the request unit 250 of the terminal device 200 sends a timeline request to the server device 300. When the request receiving unit 350 of the server device 300 receives the timeline request, the acquisition unit 330 sends a review management information request that includes the access token corresponding to the external server device 400 to the external server device 400. The authentication unit 460 of the external server device 400 performs an authentication operation based on the received access token. If the authentication succeeds, the extraction unit 440 extracts review management information to be sent by referring to the tables stored in the storing unit 420, and then the feed notification unit 430 sends the extracted review management information to the server device 300 (S220). The extracted review management information includes a content ID, a content name, a first account of a review contributor, a review, a review timestamp, etc. The response unit 340 of the server device 300 sends the acquired review management information to the terminal device 200 as a timeline response. The display control unit 240 of the terminal device 200 controls, based on the review management information received by the receiving unit 230, a screen display on the display unit 220 (the display 206) to display the timeline (S240).

In the following descriptions, for simplicity, description for authentication that uses the access token and is performed when the server device 300 accesses the external server device 400 may be omitted.

Acquisition operations to acquire review management information performed by the first acquisition unit 331, the second acquisition unit 332, and the third acquisition unit 333, which are included in the acquisition unit 330, are described below. The acquisition operations described below may be performed in parallel or successively, or only one of the acquisition operations may be selected by the second user to be performed.

### 2-2-2. Review Management Information Acquisition Operation by First Acquisition Unit

FIG. 16 shows a detailed operation sequence of a review management information acquisition operation (corresponding to S220 in FIG. 15) performed by the first acquisition unit 331 of the server device 300. When the request receiving unit 350 receives the timeline request from the terminal device 200, the first acquisition unit 331 retrieves the preference information corresponding to the second account of the user of the terminal device 200 from the second user information table TS1 (the user information storing unit 321) (S221) so as to send a review management information request that includes the retrieved preference information to the external server device 400. When the external server device 400 (the feed notification unit 430) receives the review management information request, the extraction unit 440 extracts, from the review management information table TR3, review management information that includes in its text the preference information included in the review management information request (S222). The feed notification unit 430 sends the extracted review management information to the server device 300. In other words, the first acquisition unit 331 acquires review management information regarding a piece of content based on the retrieved preference information from the feed notification unit 430 of the external server device 400. As described above, the response unit 340 of the server device 300 sends the acquired review management information to the terminal device 200 as a timeline response.

In the above-described operation flow for the first acquisition unit 331, the extraction unit 440 of the external server device 400 may extract, from the content information table TR1, a content ID of a piece of content that includes, in its content name or in its content description, the preference information included in the review management information request so as to extract reviews corresponding to the extracted content ID.

### 2-2-3. Review Management Information Acquisition Operation by Second Acquisition Unit

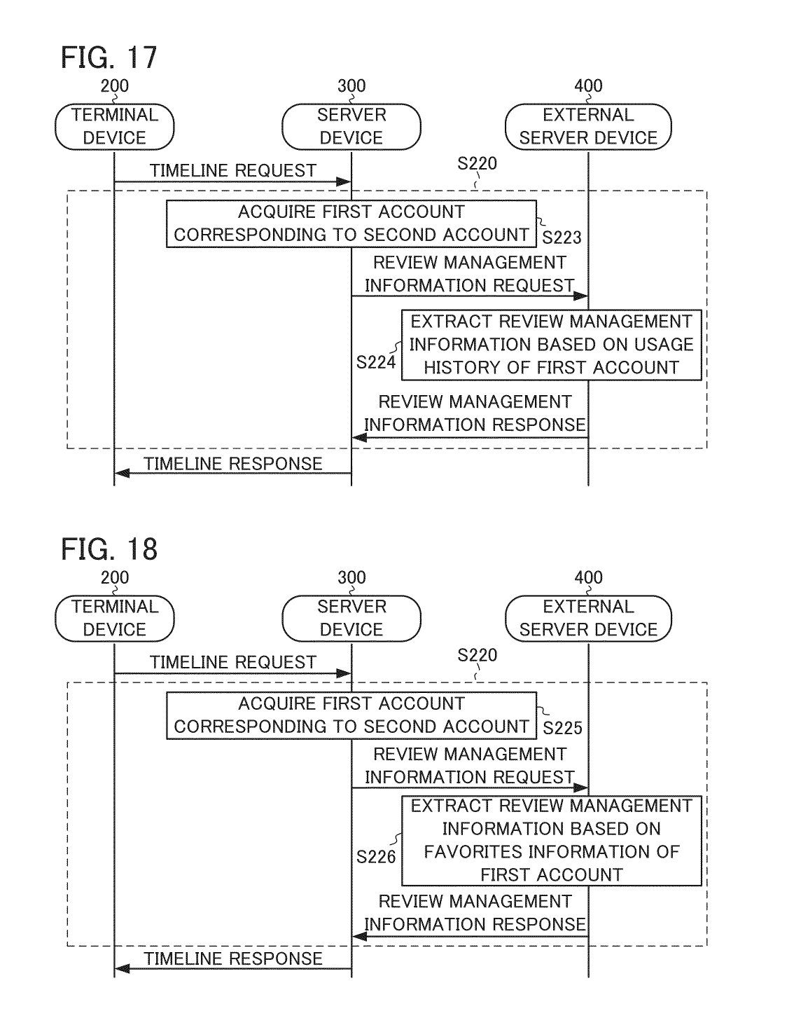

FIG. 17 shows a detailed operation sequence of a review management information acquisition operation (corresponding to S220 in FIG. 15) performed by the second acquisition unit 332 of the server device 300. When the request receiving unit 350 receives the timeline request from the terminal device 200, the second acquisition unit 332 retrieves a first account corresponding to the second account of the user of the terminal device 200 from the identification information table TS2 (the identification information storing unit 322) (S223) so as to send a review management information request that includes the retrieved first account to the external server device 400. When the external server device 400 (the feed notification unit 430) receives the review management information request, the extraction unit 440 first extracts, from the first user information table TR2, usage history information that corresponds to the first account included in the review management information request, and then, from the review management information table TR3, the extraction unit 440 extracts review management information regarding a piece of content that corresponds to the extracted usage history information (S224). The feed notification unit 430 sends the extracted review management information to the server device 300. In other words, using the retrieved first account, the second acquisition unit 332 acquires review management information regarding, among pieces of content managed by the external server device 400, a piece of content based on the usage history information of the user in the external server device 400 from the feed notification unit 430 of the external server device 400. As described above, the response unit 340 of the server device 300 sends the acquired review management information to the terminal device 200 as a timeline response.

In the above-described operation flow for the second acquisition unit 332, the extraction unit 440 of the external server device 400 may acquire, from the external server device 400, review management information regarding a piece of content (e.g., a piece of content that has a common author or a common category) that is based on attribute information (e.g., an author of a piece of content, a category to which a piece of content belongs) of the piece of content that is based on the extracted usage history information. In other words, the second acquisition unit 332 of the server device 300 may acquire review management information regarding a piece of content that is based on attribute information of a piece of content that is based on usage history information from the external server device 400.

### 2-2-4. Review Management Information Acquisition Operation by Third Acquisition Unit

FIG. 18 shows a detailed operation sequence of a review management information acquisition operation (corresponding to S220 in FIG. 15) performed by the third acquisition unit 333 of the server device 300. When the request receiving unit 350 receives the timeline request from the terminal device 200, the third acquisition unit 333 retrieves a first account corresponding to the second account of the user of the terminal device 200 from the identification information table TS2 (the identification information storing unit 322) (S225) so as to send a review management information request that includes the retrieved first account to the external server device 400. When the external server device 400 (the feed notification unit 430) receives the review management information request, the extraction unit 440 first extracts, from the first user information table TR2, favorites information that corresponds to the first account included in the review management information request, and then, from the review management information table TR3, the extraction unit 440 extracts review management information regarding a piece of content that corresponds to the extracted favorites information (S226). The feed notification unit 430 sends the extracted review management information to the server device 300. In other words, using the retrieved first account, the third acquisition unit 333 acquires review management information regarding, among pieces of content managed by the external server device 400, a piece of content that has been registered beforehand with the external server device 400 (i.e., a piece of content that is identifiable by the favorites information) by the user from the feed notification unit 430 of the external server device 400. As described above, the response unit 340 of the server device 300 sends the acquired review management information to the terminal device 200 as a timeline response.

In the above-described operation flow for the third acquisition unit 333, the extraction unit 440 of the external server device 400 may acquire, from the external server device 400, review management information regarding a piece of content that is based on attribute information of the piece of content that is identifiable by the extracted favorites information. In other words, the third acquisition unit 333 of the server device 300 may acquire review management information regarding a piece of content that is based on attribute information of pieces of content that the user has registered beforehand from the external server device 400.

### 2-2-5. Additional Configuration for Review Management Information Acquisition Operation

A following configuration can be used for each of the review management information acquisition operations described above.

Review management information extracted by the extraction unit 440 of the external server device 400 may include a first image link of a first user who posted the extracted review. Similarly, extracted review management information may include a rating value given by a first user who posted the review. Similarly, extracted review management information may include a content image link that corresponds to the reviewed piece of content (a content ID).

### 2-3. Screen Display (Review)

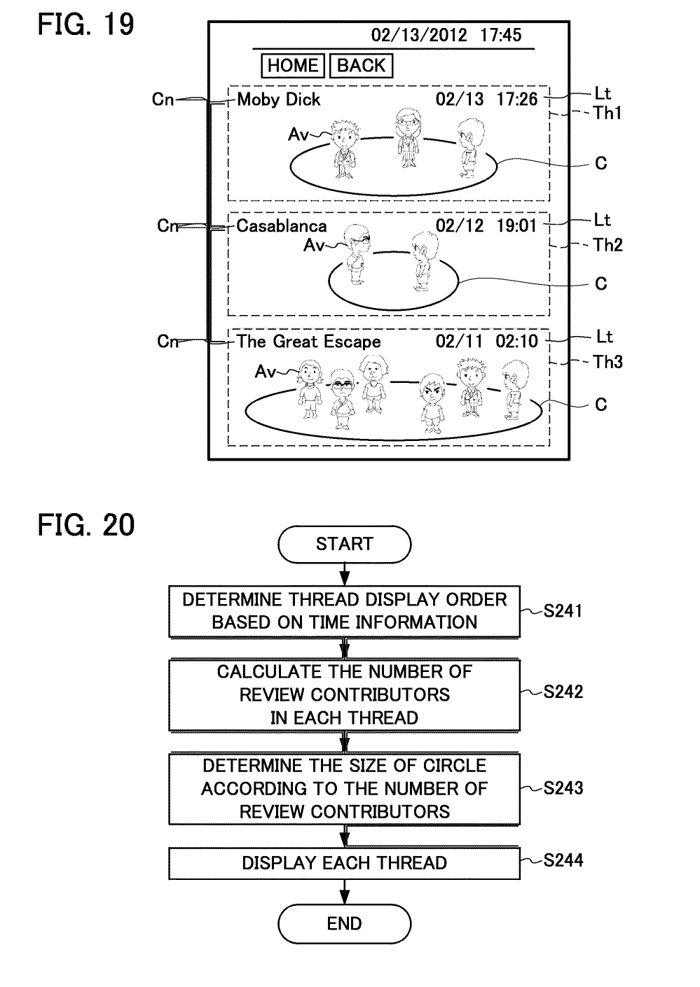

FIG. 19 illustrates an example of a screen of the SNS site (a timeline screen) that is displayed on the display 206 of the terminal device 200 by the display process (S240) described by referring to FIG. 15. As stated above, a first user can post a review of each piece among pieces of content managed by the external server device 400, and a single piece of content can have multiple reviews. In a configuration in which posted reviews are displayed in chronological order regardless of for which piece of content the reviews are posted, reviews of a single piece of content are scattered over a timeline. Thus, it is difficult for a user to browse reviews for a single piece of content of his or her interest. In view of the situation above, in the present embodiment, at least one review regarding a single piece of content is collected in a review thread Th, and a screen display (timeline display) is controlled in units of review threads Th.

The example of the timeline screen illustrated in FIG. 19 displays three review threads (Th1, Th2, and Th3) in chronological order. Each review thread Th is displayed based on review management information that corresponds to a single piece of content (a content ID). Review management information corresponding to each of the review threads Th is acquired by the first acquisition unit 331, the second acquisition unit 332, or the third acquisition unit 333. In other words, review threads based on the review management information acquired by the first acquisition unit 331, the second acquisition unit 332, and the third acquisition unit 333 can be displayed together on the timeline screen. In the example shown in FIG. 19, review management information of the review thread Th1 is acquired by the first acquisition unit 331, review management information of the review thread Th2 is acquired by the second acquisition unit 332, and review management information of the review thread Th3 is acquired by the third acquisition unit 333.

According to the configuration described above, reviews (a review thread Th) of pieces of content that are selected based on various kinds of information including the usage history information of the second user are presented to the second user. Thus, compared with a configuration in which a piece of content is selected based on a single piece of information, reviews of a more suitable piece of content can be presented to the second user.

The review thread Th includes a content name Cn of the piece of content that is being reviewed on the review thread Th, a latest posting time Lt, a user image Av, and a circle C. The latest posting time Lt is a review timestamp that corresponds to the latest review among reviews in the review thread Th. The user image Av is an image that corresponds to a user who posted a review of the piece of content corresponding to the review thread Th. For example, the user image Av may be an avatar image of the user. The circle C is a display area for the user image Av. In the circle C, a group of at least one user image Av corresponding to at least one review of the piece of content corresponding to the review thread Th is displayed. Thus, since user images Av of users who posted reviews for the same piece of content are displayed in a predetermined display area, the number of users who posted reviews can be grasped intuitively for each review thread Th.

For a user who posted multiple reviews for a single piece of content, a single user image Av of the user is displayed (alternatively, a plurality of the same user image Av may be displayed according to the number of reviews posted). As the number of users who posted reviews for the piece of content corresponding to the review thread Th increases (i.e., as the number of the grouped user images Av increases), the size of the circle C displayed becomes larger. Thus, for each review thread Th (each piece of content), the number of users who posted reviews can be grasped more intuitively.

The review threads Th are displayed in descending order of the latest posting time Lt (from the latest to the oldest) on the screen. The user can view an older review thread Th on the screen by scrolling down by sliding (flicking).

FIG. 20 shows an operation flow of the display process (S240). The display control unit 240 of the terminal device 200 identifies the latest posting time Lt for each of the review threads Th from review timestamps of reviews included in the respective review threads Th. Then, the display control unit 240 of the terminal device 200 determines the order in which the review threads Th are displayed so that they are displayed in descending order of the latest posting time Lt (S241). Subsequently, the display control unit 240 calculates the number of review contributors for each of the review threads Th (S242) and determines the size of the circle C according to the number of the review contributors (S243). Alternatively, the size of the circle C may be determined according to the number of reviews in each review thread Th.

After step S243, for each review thread Th, the display control unit 240 displays the content name Cn, the identified latest posting time Lt, the circle C with the determined size, and user images Av corresponding to the respective reviews on the display unit 220 (S244). A manner in which user images Av to be displayed are selected is described later in detail.

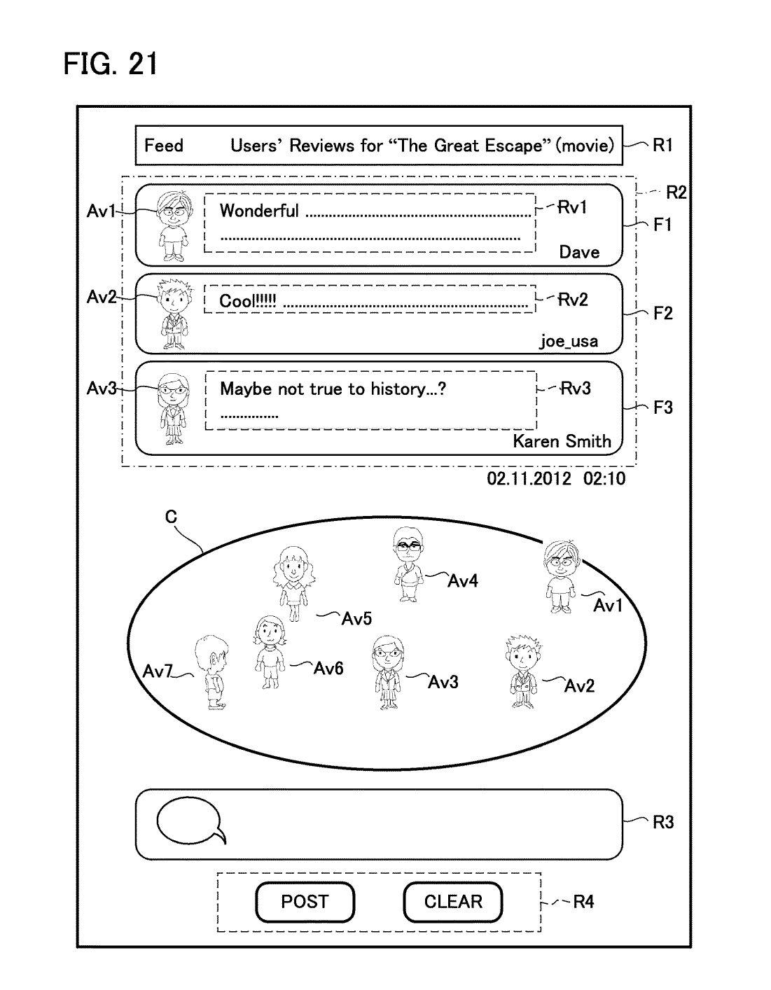

The display control unit 240 controls the display unit 220 so that when the user of the terminal device 200 taps on any of the review threads Th (e.g., the review thread Th1) on the timeline screen shown in FIG. 19, a review thread detail screen as shown in FIG. 21 is displayed. The review thread detail screen includes a content information display area R1, a review display area R2, a circle C in which a user image Av is displayed, an input area R3, and an operation button area R4. The input area R3 and the operation button area R4 are used when, for example, a user posts a new review, as described later.

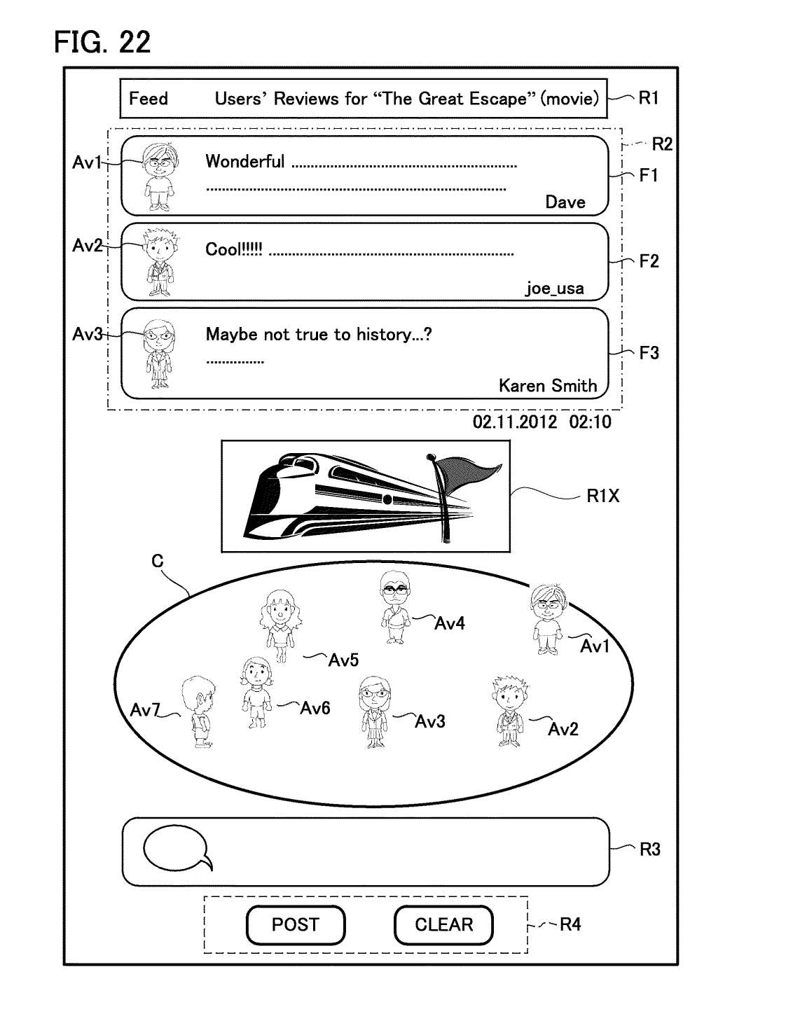

In the content information display area R1, a content name of the piece of content that corresponds to the review thread Th is displayed. Along with the content name, other content-related information (e.g., a name of an author of the piece of content) may also be displayed in the content information display area R1. Furthermore, as shown in FIG. 22, the display control unit 240 may make the display unit 220 display an image that is specified by a content image link included in review management information corresponding to the review thread Th in a content image display area R1X. According to the configuration described above, since reviews (review thread Th) of a piece of content and a content image of the piece of reviewed content are displayed together, a correspondence between the reviews and the piece of reviewed content can be grasped easily.

The review display area R2 includes an individual review display field F (F1, F2, F3, etc.) displaying a review corresponding to the review thread Th that includes at least one review. In the individual review display field F, a review (e.g., a review Rv1) and a user image Av (e.g., a user image Av1) of a first user (the contributor of the review), the user image being specified based on a first image link corresponding to the review, are displayed in association with each other. Individual review display fields F are displayed in descending order of review timestamp (from the latest to the oldest) in the review display area R2.

When the number of reviews included in the review thread Th exceeds the maximum number of reviews that can be displayed in the review display area R2 at a time, the user can view older reviews by scrolling down the review display area R2 by sliding (flicking).

In the circle C, the same image (an image that indicates the review contributor) as a user image Av (Av1, Av2, Av3, etc.) displayed in each individual review display field F is displayed. Moreover, the user image Av displayed in the circle C on the review thread detail screen (FIG. 21) and the user image Av displayed in the circle C in the review thread Th on the timeline screen (FIG. 19) corresponding to the review thread detail screen are virtually the same.

According to the configuration described above, since a review and a user image Av that corresponds to the review's contributor are displayed together, it is easier for a review-browsing user to distinguish review contributors from one another.

### 2-3-1. Selection of User Image

On the timeline screen and the review thread detail screen described above by referring to FIGS. 19 to 22, an image specified by a first image link that corresponds to each review and is included in review management information is displayed as a user image Av. Described below are two examples of a configuration in which a different image is displayed as a user image Av.

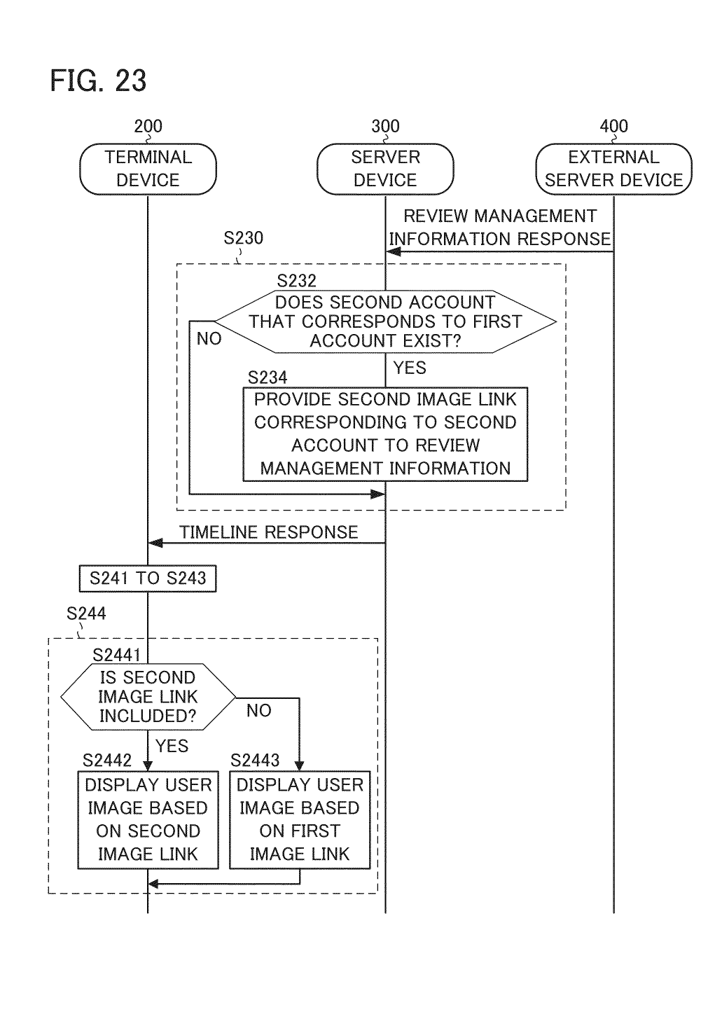

FIG. 23 shows an operation sequence that describes, in more detail, operations performed after the review management information response in the operation sequence shown in FIG. 15.

Upon acquiring the extracted review management information from the external server device 400, the response unit 340 of the server device 300 determines whether the second account corresponding to the first account included in the review management information is stored in the identification information table TS2 (the identification information storing unit 322) (S232). If the condition for determination described above is satisfied, the response unit 340 associates a second image link of the second account corresponding to the first account with the first account and adds the second image link to the review management information (S234). The conditional second-image-link-adding operation (S230) described above is performed for each first account acquired.

Once step S230 is completed, the response unit 340 of the server device 300 sends the review management information added with the second image link to the terminal device 200 as a timeline response. When the receiving unit 230 of the terminal device 200 receives the review management information, the display control unit 240 displays a timeline screen according to the display process flow described by referring to FIG. 20. At step S244 of the display process flow, the display control unit 240 determines, for each review included in each review thread Th, whether the received review management information includes a second image link (S2441). If a second image link is included, the display control unit 240 displays, as a user image Av, an image specified by the second image link preferentially to an image specified by the first image link (S2442). On the other hand, if a second image link is not included, the display control unit 240, as described above, displays an image specified by the first image link as a user image Av (S2443). Operations other than selection and display of the user image Av are similar to those at steps S241 to S243 of the display process flow described above. On the review thread detail screen, determination as described above is performed to select a user image Av to be displayed.

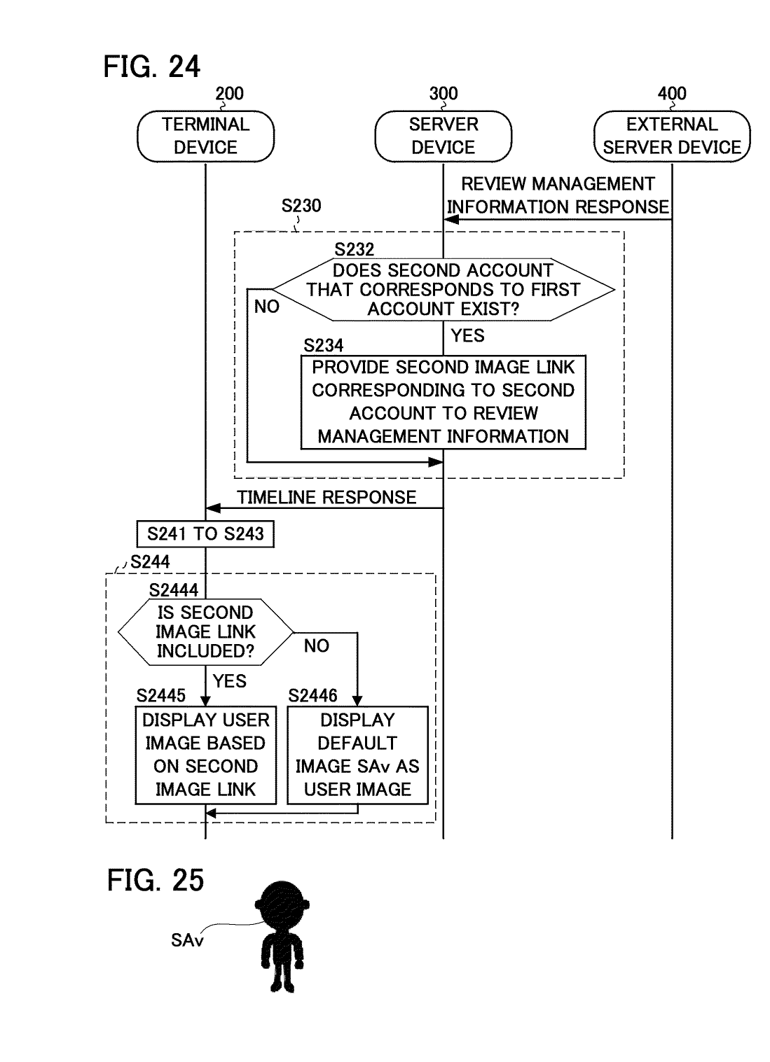

FIG. 24 shows an operation sequence that describes, in more detail, operations performed after the review management information response in the operation sequence shown in FIG. 15. Below, only step S244 that differs from steps in the operation sequence shown in FIG. 23 is described.

At step S244 of the display process flow, for each review included in each review thread Th, the display control unit 240 determines whether the received review management information includes a second image link (S2444). If a second image link is included, the display control unit 240 displays, as a user image Av, an image specified by the second image link (S2445). On the other hand, if a second image link is not included, the display control unit 240 displays a predetermined default user image SAv as a user image Av (S2446). FIG. 25 shows an example of the default user image SAv. Multiple default user images SAv that vary according to the age or gender of users may also be used. Operations other than selection and display of the user image Av are similar to those in the display process flow described above. On the review thread detail screen, determination as described above is performed to select a user image Av to be displayed.

According to the configurations (FIG. 23 and FIG. 24) described above, since user images used in the SNS site (the server device 300) are displayed in association with reviews acquired from the review site (the external server device 400) if review contributors of the reviews are also registered with the SNS site, it is easier for a user of the SNS site to distinguish review contributors from one another.

### 2-3-2. Display of Review and User Image Based on Rating Value

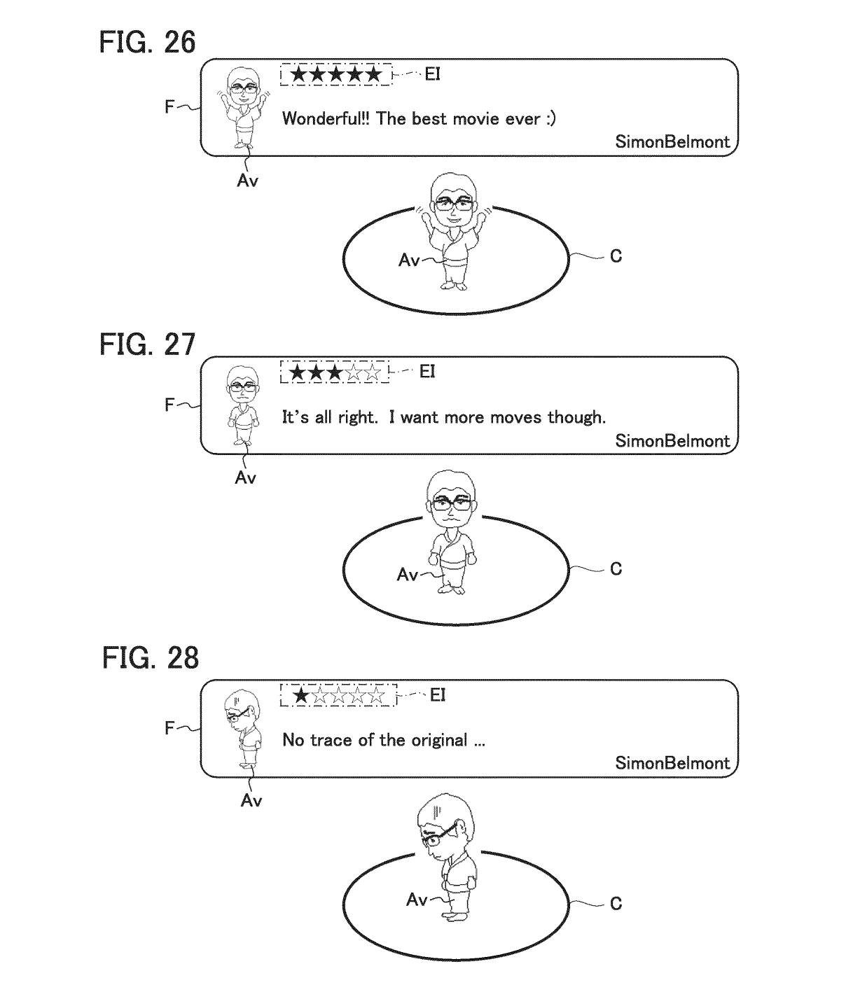

Display of a review and a user image Av when review management information includes a rating value for a piece of content is described by referring to FIGS. 26 to 28. As described above, review management information can include a five-level rating value given by a first user who posted the review.

FIG. 26 shows an example of the individual review display field F and the user image Av when the rating value is “5” (the highest rating). In the example above, the display control unit 240 displays a rating display EI with five solid star symbols that correspond to the rating value “5” in the individual review display field F.

Furthermore, in the example above, the display control unit 240 displays, as the user image Av, an image of a form that corresponds to the rating values “4” and “5” (values higher than the median “3”) and expresses satisfaction in the individual review display field F and in the circle C.

FIG. 27 shows an example of the individual review display field F and the user image Av when the rating value is “3” (the average rating). In the example above, the display control unit 240 displays a rating display EI with three solid star symbols that correspond to the rating value “3” in the individual review display field F.

Furthermore, in the example above, the display control unit 240 displays, as the user image Av, an image of a form that corresponds to the rating value “3” and expresses no emotions in the individual review display field F and in the circle C.

FIG. 28 shows an example of the individual review display field F and the user image Av when the rating value is “1” (the lowest rating). In the example above, the display control unit 240 displays a rating display EI with one solid star symbol that corresponds to the rating value “1” in the individual review display field F.

Furthermore, in the example above, the display control unit 240 displays, as the user image Av, an image of a form that corresponds to the rating values “1” and “2” (values lower than the median “3”) and expresses disappointment in the individual review display field F and in the circle C.

If a single first user has posted multiple reviews, the user image Av is displayed based on the rating value corresponding to the latest posting. Alternatively, the user image Av may be displayed based on some other standards.

As described above, the display control unit 240 changes a display form of the user image Av to display on the display unit 220 based on the rating value by the first user corresponding to the user image Av. A manner of implementing the configuration described above may be freely chosen. For example, image links (first image links or second image links) to images that correspond to respective display forms may be associated with a single account (a first account or a second account) and stored in a storing unit (the storing unit 420 or the user information storing unit 321). Moreover, as a display form, the display control unit 240 may enlarge the user image Av with higher rating values or may change the color (e.g., the intensity) of the user image Av depending on the rating value for displaying. Since there is no need to have multiple images, the configurations above are easy to implement.

According to the configurations described above, review-browsing second users of the SNS site can intuitively grasp ratings for a piece of content by first users (review contributors).

### 2-4. Point Giving

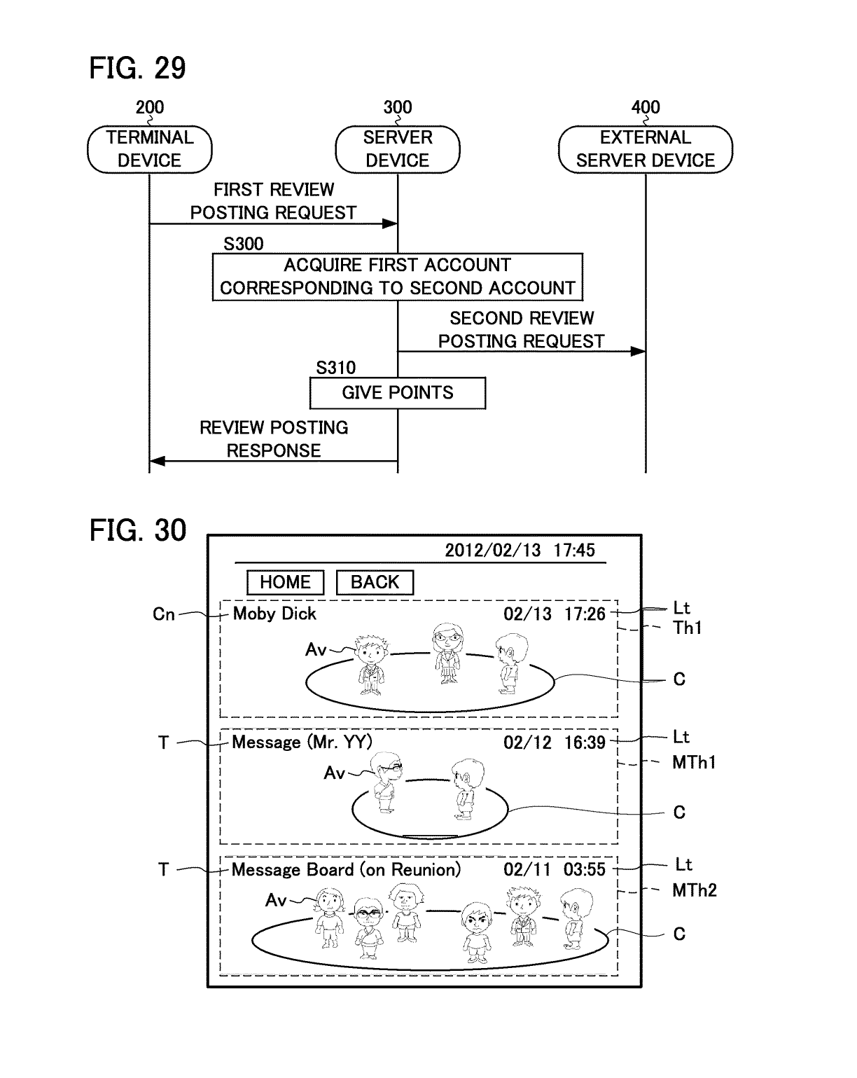

The second user can post a review to the external server device 400 using the review thread detail screen (FIG. 21) of the SNS site. FIG. 29 shows an operation sequence of a review posting through the SNS site (the server device 300).

Using the terminal device 200 (the input unit 205), in the input area R3 on the review thread detail screen as shown in FIG. 21, the second user can write a review of a piece of content corresponding to the review thread detail screen. When the second user presses the post button in the operation button area R4, a first review posting request that includes the review written in the input area R3 and a content ID corresponding to the review thread detail screen is sent from the request unit 250 of the terminal device 200 to the server device 300. Upon receiving the first review posting request, the server device 300 (the posting unit 360) retrieves a first account and an access token that correspond to the second account of the review-posting second user from the identification information table TS2 (the identification information storing unit 322) (S300) so as to send a second review posting request that includes the retrieved first account, the retrieved access token, and the review and the content ID included in the first review posting request to the external server device 400 in order to post the review of the piece of content corresponding to the review thread detail screen.

Once the review posting is completed, the point giving unit 370 of the server device 300 increases the number of points that is stored in the point information table TS3 (the point storing unit 323) and is associated with the second account corresponding to the second user who posted the review (S310). An increment of the points can be a predetermined value. For every predetermined number of review postings, bonus points may be given in addition to the predetermined number of points. After step S310, a review posting response indicating that the review posting has been completed and points have been given is sent from the server device 300 to the terminal device 200.

According to the configuration described above, since the points, which are usable within the server device 300 (the SNS site), are given to a second user when the second user posts a review, the second user is motivated to post a review. Furthermore, since the points in the server device 300 (the SNS site) are given according to review postings to the external server device 400 (the review site), even if the external server device 400 does not have a function to give points in relation to reviews, it is possible to motivate the user to post reviews by the point giving as described above.

### 2-5. Screen Display (Review and Other Messages)

As described above, the server device 300 (the SNS site) can perform, in addition to the acquisition of review management information from the external server device 400, the transmission and the reception of message management information between second users of the SNS site. The transmission and the reception of message management information mentioned above can be performed in parallel with the acquisition of review management information from the external server device 400. Specific operations are as described below.

The message storing unit 324 of the server device 300 associates and stores message information that indicates a message, a type information that indicates a type of the message (message board, mail, chat, etc.), a message timestamp that indicates a time (timestamp) when the message information is transmitted or received, a second account of a second user who has sent the message information, and a second account of a second user who has received the message information.

When the second user sends a timeline request to the server device 300 using the terminal device 200, the first acquisition unit 331, the second acquisition unit 332, and the third acquisition unit 333 of the server device 300 acquire review management information from the external server device 400 as described above (FIGS. 15 to 18), and the fourth acquisition unit 334 extracts and acquires message management information corresponding to the second account of the second user from the message storing unit 324. The response unit 340 sends the acquired review management information and the message management information to the terminal device 200 of the second user. The display control unit 240 of the terminal device 200 displays, based on the review timestamp included in the review management information and the message timestamp included in the message management information received by the receiving unit 230, a review thread Th that corresponds to the review management information and a message thread MTh that corresponds to the message management information in chronological order on the display unit 220. The message thread MTh is used for transmitting and receiving a series of messages (e.g., an exchange of messages with other second users by mail or chat, postings to the same message board by second users including the second user himself or herself) related to the second user.

FIG. 30 shows an example of a timeline screen displayed by the operations described above. In the example shown in FIG. 30, one review thread Th1 and two message threads (MTh1 and MTh2) are displayed in chronological order (in descending order of the latest updated time). The review thread Th1 is as described above by referring to FIG. 19. Each message thread MTh includes a thread title T, a latest posting time Lt, a user image Av, and a circle C. The thread title T is a title of the thread and is displayed based on information such as the type information of the message. Other items are similar to those of a review thread Th. The display control unit 240 controls the display unit 220 so that when the user of the terminal device 200 taps on the message thread MTh, a message thread detail screen similar to a review thread detail screen is displayed.

It can be understood from the description above that the server device 300 can display threads that correspond to message management information exchanged between second users of its own (the SNS site) and review management information acquired from the external server device 400 in chronological order on the terminal device 200.

According to the configuration described above, information from different services (review management information and message management information) are displayed in chronological order on a single timeline screen. Thus, a user of the server device 300 can browse information from multiple services without switching a screen of the terminal device 200.

Furthermore, by the review management information acquisition operations based on usage history information (e.g., FIG. 17), the server device 300 acquires review management information from the external server device 400 based on a first service usage history (usage history information) of a first user in the external server device 400, the first user being the same as a second user of the server device 300, so as to present review information to the second user. Thus, compared with a configuration in which the server device 300 presents review information based simply on a request by a second user, the server device 300 can present, to the second user, review information regarding a piece of content that is more suited to the second user's liking.

### 3. Modification

The embodiment described above can be modified in various ways. Examples of modifications are described below. Two or more of the modifications can be combined as appropriate, provided that the combined modifications do not conflict with each other.

### (1) Modification 1

In the embodiment above, as shown in the example of the timeline screen in FIG. 19, review threads corresponding to review management information based on preference information, review management information based on usage history information, and review management information based on favorites information are displayed together. However, a review thread that corresponds to review management information based on a part of the information may be displayed alone. In other words, a configuration in which the acquisition unit 330 includes, among the first acquisition unit 331, the second acquisition unit 332, the third acquisition unit 333, and the fourth acquisition unit 334, only some of the elements can be used. For example, the acquisition unit 330 may include only the first acquisition unit 331, only the second acquisition unit 332, or only the third acquisition unit 333. Alternatively, the acquisition unit 330 may include a combination of some of the elements (e.g., the first acquisition unit 331 and the fourth acquisition unit 334, the second acquisition unit 332 and the fourth acquisition unit 334, or the third acquisition unit 333 and the fourth acquisition unit 334).

### (2) Modification 2

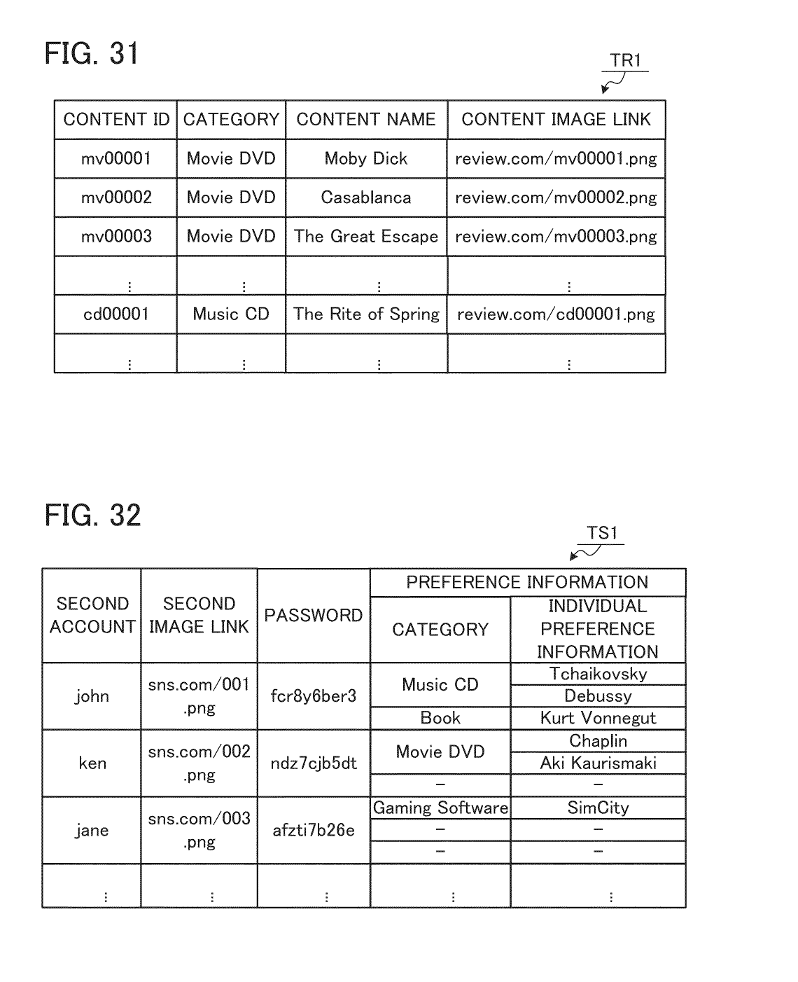

In the embodiment described above, pieces of content may be managed by categories (music CDs, books, movie DVDs, gaming software, etc.). For example, as shown in FIG. 31, in the content information table TR1 stored in the external server device 400 (the storing unit 420), pieces of content may be classified into categories to be managed, and as shown in FIG. 32, in the second user information table TS1 stored in the server device 300 (the user information storing unit 321), preference information of a second user may have at least one piece of individual preference information that corresponds to at least one category. According to the configuration described above, since the individual preference information is managed by category, the user can be provided with review information that is more suited to the user's preference.

For simplicity in drawings, the content description is not shown in FIG. 31. However, the content information table TR1 of the present modification can include content description for each piece of content.

### (3) Modification 3

In the embodiment described above, a first user is identified by a first account in the external server device 400, and a second user is identified by a second account in the server device 300. However, in each server device, various pieces of information related to a user can be stored, and the user can be identified by any piece of information (identifier). For example, the user may be identified by the user's email address. Similarly, the user may be identified by a combination of pieces of information.

### (4) Modification 4

In the embodiment described above, preference information (individual preference information) stored in the second user information table TS 1 is expressed as text data; however, it may be expressed by alternatives. Specifically, when a second user registers preference information, the server device 300 may present, to the second user, alternatives such as categories (e.g., movies) and sub-categories (e.g., action movies). The second user then may make choices from the presented alternatives according to his or her preference in order to register preference information with the server device 300. The second user information table TS 1 may store preference information both by alternatives and by text data.

### (5) Modification 5

In the embodiment described above, an avatar image, which shows a full-body image corresponding to a user (a graphical representation of the user), is used as a user image Av. However, any image that identifies the user can instead be used as a user image Av. Moreover, in the embodiment described above, an avatar image may be displayed as a two-dimensional image or as a three-dimensional image.

### (6) Modification 6

On the review thread detail screen in the embodiment described above, for each user, the user image Av displayed in the review display area R2 (the individual review display field F) is the same as the user image Av displayed in the circle C. However, these images may differ from each other. For example, a configuration in which, for a given user, a profile image (a photo or a portrait) corresponding to the user is displayed in the individual review display field F, and an avatar image corresponding to the user is displayed in the circle C can be used. In the configuration described above, it is understood, as a matter of course, that a combination of an image link that specifies the avatar image and an image link that specifies the profile image is stored as a first image link or as a second image link of the embodiment.

### (7) Modification 7

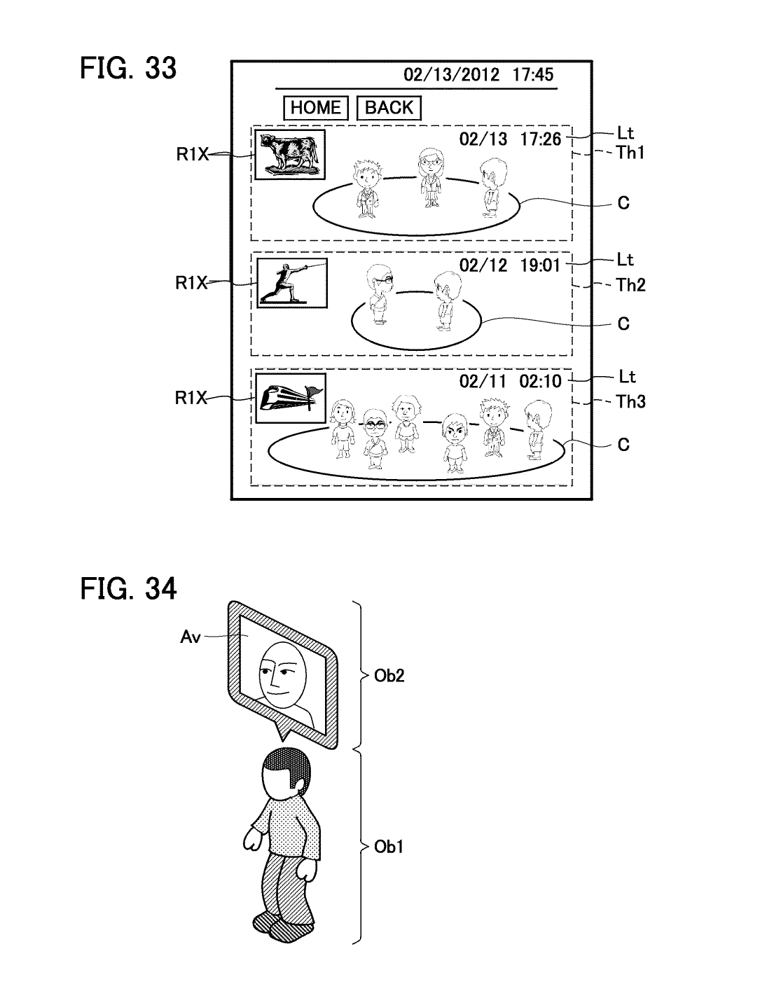

As shown in FIG. 33, on the timeline screen on the display unit 220, each review thread Th may have a content image display area R1X in which an image specified by a content image link included in review management information corresponding to the review thread Th is displayed.

### (8) Modification 8

On the review thread detail screen as shown in figures such as FIG. 21, each individual review display field F or the operation button area R4 may have a rating button (e.g., a “Like” button) used to evaluate each review. When the rating button is pressed, the terminal device 200 may send a one-click rating response related to the review to the server device 300.

A one-click response can be used for various control purposes. For example, the size of the circle C in each review thread Th can be modified according to a one-click rating response sent in the review thread Th. Moreover, according to the number of one-click rating responses gained by a review, the points can be additionally given to a user who posted the review. Furthermore, the points can be given to a user who has sent a one-click rating response. The number of points given to the user who has sent a one-click rating response may or may not be the same as the number of points given when a review is posted.

### (9) Modification 9

In the embodiment described above, as shown in FIG. 34, a user image Av may be displayed as a combination of a mascot Ob1 and an identification label Ob2. The mascot Ob1 is a three-dimensional display object that imitates a human form, and the identification label Ob2 is a two-dimensional display object that shows a user image Av with a rectangular frame around it. The identification label Ob2 is placed in the proximity of (above) the mascot Ob1. Preferably, the above-mentioned profile image is used for the user image Av. In the configuration above, since a general form is used for the mascot Ob1, it is easy to make the mascot Ob1 do various moves according to, for example, a rating value. Moreover, if the mascot Ob1 is displayed as a three-dimensional image, the mascot Ob1 can be made to make complicated moves.

### (10) Modification 10

In the embodiment described above, the server device 300 can display threads that correspond to message management information exchanged between second users of its own (the SNS site) and review management information acquired from the external server device 400 in chronological order.

However, the server device 300 may have a function only to acquire review management information from the external server device 400 so as to display a review thread Th in chronological order. Alternatively, the server device 300 may have a function only to acquire review management information and message management information exchanged between second users of the SNS site so as to display respective threads in chronological order.

### (11) Modification 11

In the embodiment described above, the display control unit 240 constructs a screen display on the display unit 220 (the display 206) of the terminal device 200 based on at least any of review management information and message management information. However, the embodiment is not to limit the scope of the present invention. A screen display may be constructed in the server device 300 to be sent to the terminal device 200.

### (12) Modification 12

In the embodiment described above, the acquisition unit 330 (the fourth acquisition unit 334) of the server device 300 (the SNS site) can acquire and send, to the terminal device 200, along with message management information (internal message management information) from the message storing unit 324, message management information (external message management information) from another external server device (e.g., the external server device 500) that provides a microblogging service. Moreover, the acquisition unit 330 (the fourth acquisition unit 334) may acquire and send, to the terminal device 200, review management information from an external server device (e.g., the external server device 600) that provides a review site different from the review site provided by the external server device 400.

The terminal device 200 can then display, in a manner similar to the embodiment, a timeline screen and a message thread detail screen in chronological order based on, in addition to review management information acquired by the first acquisition unit 331, the second acquisition unit 332, and the third acquisition unit 333 and the internal message management information acquired by the fourth acquisition unit 334, the external message management information and/or the review management information received by the fourth acquisition unit 334.

### 4. Other Matters

The following aspects of the invention are understood from the embodiment and modifications described in the foregoing.

In one aspect, the invention is understood to be an information providing system including: a server device that is communicably connected to an external server device, the external server device accumulating review management information that includes review information that indicates a review of a piece of content by a first user and first identification information that corresponds to the first user, the external server device associating and storing the first identification information and history information that indicates a service usage history of the first user, the external server device providing a first service that includes a browsing service that makes the review of the piece of content by the first user browsable, the server device providing a second service to each second user; and a terminal device that the second user operates. The server device includes: an acquisition unit configured to, upon receiving a request from the terminal device of the second user, retrieve the first identification information corresponding to second identification information of the second user from an identification information storing unit that associates and stores first identification information corresponding to a user and second identification information corresponding to the same user so as to acquire, using the retrieved first identification information, review management information regarding, from among pieces of content managed by the external server device, at least one of a piece of content based on a first service usage history of the second user in the external server device and a piece of content based on attribute information of the piece of content; and a response unit configured to send the review management information acquired by the acquisition unit to the terminal device. The terminal device includes: a display unit; a receiving unit that is configured to receive the review management information from the server device; and a display control unit that is configured to control a screen display on the display unit based on the review management information received by the receiving unit. The information providing system 1, the server device 300, and the terminal device 200 are respectively non-limiting examples of such an information providing system, a server device, and a terminal device according to the present invention. According to the above embodiment, which is non-limiting, the server device 300 and the terminal device 200 are interconnected through the network 100. The server device 300 is connected to each of the external server devices 400, 500, 600, etc., which are non-limiting examples of such an external server device according to the present invention. The acquisition unit 330, the identification information storing unit 322, the response unit 340, the display unit 220, the receiving unit 230, and the display control unit 240 are respectively non-limiting examples of such an acquisition unit, an identification information storing unit, a response unit, a display unit, a receiving unit, and a display control unit according to the present invention. The information stored in the review management information table TR3, and the review and the first account, both of which are included in the information, are respectively non-limiting examples of such review management information, review information, and first identification information according to the present invention. Similarly, the usage history information stored in the first user information table TR2 and the second account stored in the identification information table TS2 are respectively non-limiting examples of such history information and second identification information according to the present invention.

In a preferred embodiment, the first service may include a sale of at least one of a commodity and a service. The acquisition unit may acquire review management information regarding at least one of a piece of content based on a history of the sale of at least one of the commodity and the service for the user in the external server device and a piece of content based on attribute information of the piece of content.

In a preferred embodiment, the review management information acquired by the acquisition unit may include information related to a first user image of the first user who has posted the review that is managed by the external server device. The response unit may send the review management information including the information related to the first user image to the terminal device. The display control unit, based on the review management information, may associate and display the review indicated by the review information and the first user image that is based on the information related to the first user image on the display unit. The first image link stored in the first user information table TR2 is a non-limiting example of such information related to a first user image of the first user according to the present invention.

Preferably, the response unit, when the second identification information corresponding to the first identification information that is included in the review management information acquired by the acquisition unit is stored in the identification information storing unit, may retrieve information related to a second user image corresponding to the second identification information from a user information storing unit that associates and stores the second identification information corresponding to the second user and user information that is related to the second user and includes the information related to the second user image of the second user so as to add the retrieved information to the review management information before sending the review management information to the terminal device. The display control unit, when the review management information received by the receiving unit includes the information related to the second user image, based on the information related to the second user image, may display the second user image preferentially to the first user image on the display unit. The user information storing unit 321 is a non-limiting example of such a user information storing unit according to the present invention. Similarly, the information stored in the second user information table TS 1 and the second image link included in the information are respectively non-limiting examples of such user information and information related to a second user image of the second user according to the present invention.

The “information related to the second user image” is a concept that includes: an indicator of a location where a user image that corresponds to the second user is stored (e.g., an image link); and data of a user image that corresponds to the second user.

In another preferred embodiment, the response unit, when the second identification information corresponding to the first identification information that is included in the review management information acquired by the acquisition unit is present, may retrieve information related to a second user image corresponding to the second identification information from a user information storing unit that associates and stores the second identification information corresponding to the second user and user information that is related to the second user and includes the information related to the second user image of the second user so as to add the retrieved information to the review management information before sending the review management information to the terminal device. The display control unit, when the review management information received by the receiving unit includes the information related to the second user image, based on the information related to the second user image, may display the second user image on the display unit, and when the review management information received by the receiving unit does not include the information related to the second user image, the display control unit may display a predetermined user image on the display unit. The predetermined default user image SAv as shown in FIG. 25 is a non-limiting example of such a predetermined user image according to the present invention.

The situation in which the second identification information corresponding to the first identification information is present includes a situation in which the second identification information corresponding to the first identification information is stored in the identification information storing unit.

In still another preferred embodiment, the review management information acquired by the acquisition unit may include a rating value given by the first user who posted the review. The response unit may send the review management information that includes the rating value to the terminal device. The display control unit may change, according to the rating value, a display form of a user image to display on the display unit. The rating display EI and the user image Av, as shown in FIGS. 26 to 28, are respectively non-limiting examples of a manner in which such a rating value according to the present invention is displayed, and a manner in which such a display form of a user image is changed according to a rating value, according to the present invention.

In yet another preferred embodiment, the display control unit may display a group of at least one user image corresponding to at least one review of a piece of content in a predetermined display area on the display unit. The circle C is a non-limiting example of such a predetermined display area according to the present invention.

Preferably, the display control unit may display the group the of at least one user image in the predetermined display area that is enlarged according to the number of user images included in the group on the display unit.

In still another preferred embodiment, the review management information acquired by the acquisition unit may include information related to a content image corresponding to a piece of reviewed content. The response unit may send the review management information including the information related to the content image to the terminal device. The display control unit may display, based on the information related to the content image, the content image that corresponds to the review of the piece of reviewed content on the display unit. The content image link stored in the content information table TR1 is a non-limiting example of such information related to a content image corresponding to the piece of reviewed content according to the present invention. Similarly, the content image display area R1X as shown in FIG. 22 is a non-limiting example of an area for displaying such a content image according to the present invention.

In yet another preferred embodiment, the server device may include: a posting unit configured to, upon receiving a request from the terminal device operated by the user, post a review of any piece among pieces of content; and a point giving unit configured to, when a review is posted via the posting unit, increase the number of points that is associated with the second identification information corresponding to the second user who has posted the review, the points being usable within the second service. The posting unit 360 and the point giving unit 370 are respectively non-limiting examples of such a posting unit and a point giving unit according to the present invention.

In still another preferred embodiment, the review management information accumulated in the external server device may include time information indicating a posting time of the review information. The acquisition unit may acquire, in addition to the review management information regarding the piece of content based on the first service usage history of the second user, review management information regarding a piece of content based on other information from the external server device. The display control unit, based on the time information in the review management information acquired by the acquisition unit, may display the review information in chronological order on the display unit. The review timestamp stored in the review management information table TR3 is a non-limiting example of such time information accumulated in the external server device according to the present invention. The review management information regarding a piece of content extracted based on preference information and based on favorites information is a non-limiting example of such review management information regarding a piece of content based on other information according to the present invention.

Preferably, the second service may include a service in which the second user exchanges message management information with other second user, the message management information including message information that indicates a message and message time information that indicates the exchange time of the message information. The response unit may send the review management information and the message management information to the terminal device of the second user. The display control unit, based on the time information included in the review management information and the message time information included in the message management information, may display the review information and the message information in chronological order on the display unit. The message management information stored in the message storing unit 324 and the message information and the message timestamp, both of which are included in the message management information, are respectively non-limiting examples of such message management information, message information, and message time information according to the present invention.

In still yet another preferred embodiment, the review management information accumulated in the external server device may include time information indicating a posting time of the review information. The second service may include a service in which the second user exchanges message management information with other second user, the message management information including message information that indicates a message and message time information that indicates the exchange time of the message information. The response unit may send the review management information and the message management information to the terminal device of the second user. The display control unit, based on the time information included in the review management information and the message time information included in the message management information, may display the review information and the message information in chronological order on the display unit.

In another aspect, the present invention is understood to be a server device configured to communicate with an external server device, the external server device accumulating review management information that includes review information that indicates a review of a piece of content by a first user and first identification information that corresponds to the first user, associating and storing the first identification information and history information that indicates a service usage history of the first user, and providing a first service that includes a browsing service that makes the review of the piece of content by the first user browsable. The server device is used in an information providing system that includes a terminal device, the terminal device being operated by a second user and displaying the review information. The server device provides a second service to each second user. The server device includes: an acquisition unit configured to, upon receiving a request from the terminal device of the second user, retrieve the first identification information corresponding to second identification information of the second user from an identification information storing unit that associates and stores first identification information corresponding to a user and second identification information corresponding to the same user so as to acquire, using the retrieved first identification information, review management information regarding, from among pieces of content managed by the external server device, at least one of a piece of content based on a first service usage history of the second user in the external server device and a piece of content based on attribute information of the piece of content; and a response unit configured to send the review management information acquired by the acquisition unit to the terminal device.

In a preferred embodiment, the response unit, when the second identification information corresponding to the first identification information that is included in the review management information acquired by the acquisition unit is stored in the identification information storing unit, may retrieve information related to a second user image corresponding to the second identification information from a user information storing unit that associates and stores the second identification information corresponding to the second user and user information that is related to the second user and includes the information related to the second user image of the second user so as to add the retrieved information to the review management information before sending the review management information to the terminal device.

In yet another aspect, the present invention is understood as a non-transitory recording medium storing a computer program that is executed in a processor in a computer. The computer communicates with an external server device, the external server device accumulating review management information that includes review information that indicates a review of a piece of content by a first user and first identification information that corresponds to the first user, associating and storing the first identification information and history information that indicates a service usage history of the first user, and providing a first service that includes a browsing service that makes the review of the piece of content by the first user browsable. The computer is used in an information providing system that includes a terminal device that is operated by a second user and displays the review information. The computer provides a second service to each second user. The computer program makes the computer function as: an acquisition unit configured to, upon receiving a request from the terminal device of the second user, retrieve the first identification information corresponding to second identification information of the second user from an identification information storing unit that associates and stores first identification information corresponding to a user and second identification information corresponding to the same user so as to acquire, using the retrieved first identification information, review management information regarding, from among pieces of content managed by the external server device, at least one of a piece of content based on a first service usage history of the second user in the external server device and a piece of content based on attribute information of the piece of content; and a response unit configured to send the review management information acquired by the acquisition unit to the terminal device.

In a preferred embodiment, the response unit, when the second identification information corresponding to the first identification information that is included in the review management information acquired by the acquisition unit is stored in the identification information storing unit, may retrieve information related to a second user image corresponding to the second identification information from a user information storing unit that associates and stores the second identification information corresponding to the second user and user information that is related to the second user and includes the information related to the second user image of the second user so as to add the retrieved information to the review management information before sending the review management information to the terminal device.

The computer program according to the present invention can be provided by being stored in a non-transitory computer-readable recording medium such as a compact disk, a flexible disk, a hard disk, a magneto-optical disk, a digital versatile disk, a magnetic tape, and a semiconductor memory. Moreover, the computer program according to the present invention can be provided through a communication network (e.g., the Internet) independently of a device on which the computer program is executed. The recording medium can be provided independently of the device.

Furthermore, the computer program according to the present invention may be stored in a recording medium (e.g., a hard disk) of a distribution server that can distribute a computer program. The recording medium may be inside or outside the distribution server. The code of the computer program that is stored in the recording medium of the distribution server may be in a different form (e.g., source code or intermediate code) from a form that is executable at a terminal device (e.g., object code or native code). That is, the code of any form that is downloadable and installable at the terminal device can be stored in the recording medium. The computer program may be divided into multiple parts to be downloaded and installed at the terminal device. The parts may be downloaded from a single distribution server or multiple distribution servers to the terminal device.

In still another aspect, the present invention is understood to be a control method for a server device that communicates with an external server device, the external server device accumulating review management information that includes review information that indicates a review of a piece of content by a first user and first identification information that corresponds to the first user, associating and storing the first identification information and history information that indicates a service usage history of the first user, and providing a first service that includes a browsing service that makes the review of the piece of content by the first user browsable. The server device is used in an information providing system that includes a terminal device that is operated by a second user and displays the review information. The server device provides a second service to each second user. The control method includes: in the server device, retrieving, upon receiving a request from the terminal device of the second user, the first identification information corresponding to second identification information of the second user from an identification information storing unit that associates and stores first identification information corresponding to a user and second identification information corresponding to the same user, acquiring, using the retrieved first identification information, review management information regarding, from among pieces of content managed by the external server device, at least one of a piece of content based on a first service usage history of the second user in the external server device and a piece of content based on attribute information of the piece of content, and sending the acquired review management information to the terminal device.

In a preferred embodiment, information related to a second user image corresponding to the second identification information may be, when the acquired review management information is sent to the terminal device and if the second identification information corresponding to the first identification information that is included in the acquired review management information is stored in the identification information storing unit, retrieved from a user information storing unit that associates and stores the second identification information corresponding to the second user and user information that is related to the second user and includes the information related to the second user image of the second user so as to be added to the review management information in order to be sent to the terminal device.

In yet still another aspect, the present invention is understood to be a control method for an information providing system that includes: a server device that is communicably connected to an external server device, the external server device accumulating review management information that includes review information that indicates a review of a piece of content by a first user and first identification information that corresponds to the first user, associating and storing the first identification information and history information that indicates a service usage history of the first user, and providing a first service that includes a browsing service that makes the review of the piece of content by the first user browsable, the server device providing a second service to each second user; and a terminal device that the second user operates. The control method includes: in the server device, retrieving, upon receiving a request from the terminal device of the second user, the first identification information corresponding to second identification information of the second user from an identification information storing unit that associates and stores first identification information corresponding to a user and second identification information corresponding to the same user, acquiring, using the retrieved first identification information, review management information regarding, from among pieces of content managed by the external server device, at least one of a piece of content based on a first service usage history of the second user in the external server device and a piece of content based on attribute information of the piece of content, and sending the acquired review management information to the terminal device; and in the terminal device, receiving the review management information from the server device, and controlling a screen display of the terminal device based on the review management information received from the server device.

### REFERENCE SYMBOLS

1 . . . Information Providing System, 10 . . . Information Recording Medium, 100 . . . Network, 200 . . . Terminal Device, 204 . . . Memory Device, 205 . . . Input Unit, 206 . . . Display, 207 . . . Communication Interface, 220 . . . Display Unit, 230 . . . Receiving Unit, 240 . . . Display Control Unit, 250 . . . Request Unit, 260 . . . Storing Unit, 300 . . . Server Device, 304 . . . Hard Disk, 305 . . . Input Unit, 306 . . . Display, 307 . . . Communication Interface, 320 . . . Storing Unit, 321 . . . User Information Storing Unit, 322 . . . Identification Information Storing Unit, 323 . . . Point Storing Unit, 324 . . . Message Storing Unit, 330 . . . Acquisition Unit, 331 . . . First Acquisition Unit, 332 . . . Second Acquisition Unit, 333 . . . Third Acquisition Unit, 334 . . . Fourth Acquisition Unit, 340 . . . Response Unit, 350 . . . Request Receiving Unit, 360 . . . Posting Unit, 370 . . . Point Giving Unit, 380 . . . Authentication Unit, 390 . . . Request Unit, 400 . . . External Server Device, 404 . . . Hard Disk, 405 . . . Input Unit, 406 . . . Display, 407 . . . Communication Interface, 420 . . . Storing Unit, 430 . . . Feed Notification Unit, 440 . . . Extraction Unit, 450 . . . Post-Receiving Unit, 460 . . . Authentication Unit, 470 . . . Real-Time Clock, Av . . . User Image, C . . . Circle, Cn . . . Content Name, EI . . . Rating Display, F . . . Individual Review Display Field, Lt . . . Latest Posting Time, R1 . . . Content Information Display Area, R1X . . . Content Image Display Area, R2 . . . Review Display Area, R3 . . . Input Area, R4 . . . Operation Button Area, TR1 . . . Content Information Table, TR2 . . . First User Information Table, TR3 . . . Review Management Information Table, TS1 . . . Second User Information Table, TS2 . . . Identification Information Table, TS3 . . . Point Information Table, Th . . . Review Thread.

What is claimed:

1. An information providing system comprising:
a server device that is communicably connected to an external server device, the external server device accumulating review management information that comprises review information that indicates a review of a piece of content by a first user and first identification information that corresponds to the first user, associating and storing the first identification information and history information that indicates a service usage history of the first user, and providing a first service that comprises a browsing service that makes the review of the piece of content by the first user browsable, the server device providing a second service to each second user; and
a terminal device that the second user operates,
the server device comprising:
an acquisition unit configured to, upon receiving a request from the terminal device of the second user, retrieve the first identification information corresponding to second identification information of the second user from an identification information storing unit that associates and stores first identification information corresponding to a user and second identification information corresponding to the same user so as to acquire, using the retrieved first identification information, review management information regarding, from among pieces of content managed by the external server device, at least one of a piece of content based on a first service usage history of the second user in the external server device and a piece of content based on attribute information of the piece of content; and
a response unit configured to send the review management information acquired by the acquisition unit to the terminal device,
the terminal device comprising:
a display unit;
a receiving unit configured to receive the review management information from the server device; and
a display control unit configured to control a screen display on the display unit based on the review management information received by the receiving unit.

2. The information providing system according to claim 1,
wherein the first service comprises a sale of at least one of a commodity and a service, and
wherein the acquisition unit acquires review management information regarding at least one of a piece of content based on a history of the sale of at least one of the commodity and the service for the user in the external server device and a piece of content based on attribute information of the piece of content.

3. The information providing system according to claim 1,
wherein the review management information acquired by the acquisition unit comprises information related to a first user image of the first user who has posted the review that is managed by the external server device,
wherein the response unit sends the review management information comprising the information related to the first user image to the terminal device, and
wherein the display control unit, based on the review management information, associates and displays the review indicated by the review information and the first user image that is based on the information related to the first user image on the display unit.

4. The information providing system according to claim 3,
wherein the response unit, when the second identification information corresponding to the first identification information that is comprised in the review management information acquired by the acquisition unit is stored in the identification information storing unit, retrieves information related to a second user image corresponding to the second identification information from a user information storing unit that associates and stores the second identification information corresponding to the second user and user information that is related to the second user and comprises the information related to the second user image of the second user so as to add the retrieved information to the review management information before sending the review management information to the terminal device, and
wherein the display control unit, when the review management information received by the receiving unit comprises the information related to the second user image, based on the information related to the second user image, displays the second user image preferentially to the first user image on the display unit.

5. The information providing system according to claim 1,
wherein the response unit, when the second identification information corresponding to the first identification information that is comprised in the review management information acquired by the acquisition unit is present, retrieves information related to a second user image corresponding to the second identification information from a user information storing unit that associates and stores the second identification information corresponding to the second user and user information that is related to the second user and comprises the information related to the second user image of the second user so as to add the retrieved information to the review management information before sending the review management information to the terminal device, and
wherein the display control unit, when the review management information received by the receiving unit comprises the information related to the second user image, based on the information related to the second user image, displays the second user image on the display unit, and when the review management information received by the receiving unit does not comprise the information related to the second user image, the display control unit displays a predetermined user image on the display unit.

6. The information providing system according to claim 1,
wherein the review management information acquired by the acquisition unit comprises a rating value given by the first user who posted the review,
wherein the response unit sends the review management information that comprises the rating value to the terminal device, and
wherein the display control unit changes, according to the rating value, a display form of a user image to display on the display unit.

7. The information providing system according to claim 1,
wherein the display control unit displays a group of at least one user image corresponding to at least one review of a piece of content in a predetermined display area on the display unit.

8. The information providing system according to claim 7,
wherein the display control unit displays the group of at least one user image in the predetermined display area that is enlarged according to the number of user images comprised in the group on the display unit.

9. The information providing system according to claim 1,
wherein the review management information acquired by the acquisition unit comprises information related to a content image corresponding to a piece of reviewed content,
wherein the response unit sends the review management information comprising the information related to the content image to the terminal device, and
wherein the display control unit displays, based on the information related to the content image, the content image that corresponds to the review of the piece of reviewed content on the display unit.

10. The information providing system according to claim 1,
wherein the server device comprises:
a posting unit configured to, upon receiving a request from the terminal device operated by the user, post a review of any piece among pieces of content; and
a point giving unit configured to, when a review is posted via the posting unit, increase a number of points that is associated with the second identification information corresponding to the second user who has posted the review, the points being usable within the second service.

11. The information providing system according to claim 1,
wherein the review management information accumulated in the external server device comprises time information indicating a posting time of the review information,
wherein the acquisition unit acquires, in addition to the review management information regarding the piece of content based on the first service usage history of the second user, review management information regarding a piece of content based on other information from the external server device, and
wherein the display control unit, based on the time information in the review management information acquired by the acquisition unit, displays the review information in chronological order on the display unit.

12. The information providing system according to claim 11,
wherein the second service comprises a service in which the second user exchanges message management information with other second user, the message management information comprising message information that indicates a message and message time information that indicates an exchange time of the message information,
wherein the response unit sends the review management information and the message management information to the terminal device of the second user, and
wherein the display control unit, based on the time information comprised in the review management information and the message time information comprised in the message management information, displays the review information and the message information in chronological order on the display unit.

13. The information providing system according to claim 1,
wherein the review management information accumulated in the external server device comprises time information indicating a posting time of the review information,
wherein the second service comprises a service in which the second user exchanges message management information with other second user, the message management information comprising message information that indicates a message and message time information that indicates an exchange time of the message information,
wherein the response unit sends the review management information and the message management information to the terminal device of the second user, and
wherein the display control unit, based on the time information comprised in the review management information and the message time information comprised in the message management information, displays the review information and the message information in chronological order on the display unit.

14. A server device configured to communicate with an external server device, the external server device accumulating review management information that comprises review information that indicates a review of a piece of content by a first user and first identification information that corresponds to the first user, associating and storing the first identification information and history information that indicates a service usage history of the first user, and providing a first service that comprises a browsing service that makes the review of the piece of content by the first user browsable,
the server device being used in an information providing system that comprises a terminal device, the terminal device being operated by a second user and displaying the review information,
the server device providing a second service to each second user,
the server device comprising:
an acquisition unit configured to, upon receiving a request from the terminal device of the second user, retrieve the first identification information corresponding to second identification information of the second user from an identification information storing unit that associates and stores first identification information corresponding to a user and second identification information corresponding to the same user so as to acquire, using the retrieved first identification information, review management information regarding, from among pieces of content managed by the external server device, at least one of a piece of content based on a first service usage history of the second user in the external server device and a piece of content based on attribute information of the piece of content; and
a response unit configured to send the review management information acquired by the acquisition unit to the terminal device.

15. The server device according to claim 14,
wherein the response unit, when the second identification information corresponding to the first identification information that is comprised in the review management information acquired by the acquisition unit is stored in the identification information storing unit, retrieves information related to a second user image corresponding to the second identification information from a user information storing unit that associates and stores the second identification information corresponding to the second user and user information that is related to the second user and comprises the information related to the second user image of the second user so as to add the retrieved information to the review management information before sending the review management information to the terminal device.

16. A non-transitory recording medium storing a computer program that is executed in a processor in a computer,
the computer communicating with an external server device, the external server device accumulating review management information that comprises review information that indicates a review of a piece of content by a first user and first identification information that corresponds to the first user, associating and storing the first identification information and history information that indicates a service usage history of the first user, and providing a first service that comprises a browsing service that makes the review of the piece of content by the first user browsable,
the computer being used in an information providing system that comprises a terminal device that is operated by a second user and displays the review information,
the computer providing a second service to each second user,
the computer program making the computer function as
an acquisition unit configured to, upon receiving a request from the terminal device of the second user, retrieve the first identification information corresponding to second identification information of the second user from an identification information storing unit that associates and stores first identification information corresponding to a user and second identification information corresponding to the same user so as to acquire, using the retrieved first identification information, review management information regarding, from among pieces of content managed by the external server device, at least one of a piece of content based on a first service usage history of the second user in the external server device and a piece of content based on attribute information of the piece of content, and
a response unit configured to send the review management information acquired by the acquisition unit to the terminal device.

17. The non-transitory recording medium storing the computer program according to claim 16,
wherein the response unit, when the second identification information corresponding to the first identification information that is comprised in the review management information acquired by the acquisition unit is stored in the identification information storing unit, retrieves information related to a second user image corresponding to the second identification information from a user information storing unit that associates and stores the second identification information corresponding to the second user and user information that is related to the second user and comprises the information related to the second user image of the second user so as to add the retrieved information to the review management information before sending the review management information to the terminal device.

18. A control method for a server device,
the server device communicating with an external server device, the external server device accumulating review management information that comprises review information that indicates a review of a piece of content by a first user and first identification information that corresponds to the first user, associating and storing the first identification information and history information that indicates a service usage history of the first user, and providing a first service that comprises a browsing service that makes the review of the piece of content by the first user browsable,
the server device being used in an information providing system that comprises a terminal device that is operated by a second user and displays the review information,
the server device providing a second service to each second user,
the control method comprising:
in the server device,
retrieving, upon receiving a request from the terminal device of the second user, the first identification information corresponding to second identification information of the second user from an identification information storing unit that associates and stores first identification information corresponding to a user and second identification information corresponding to the same user,
acquiring, using the retrieved first identification information, review management information regarding, from among pieces of content managed by the external server device, at least one of a piece of content based on a first service usage history of the second user in the external server device and a piece of content based on attribute information of the piece of content, and
sending the acquired review management information to the terminal device.

19. The control method according to claim 18,
wherein information related to a second user image corresponding to the second identification information is, when the acquired review management information is sent to the terminal device and if the second identification information corresponding to the first identification information that is comprised in the acquired review management information is stored in the identification information storing unit, retrieved from a user information storing unit that associates and stores the second identification information corresponding to the second user and user information that is related to the second user and comprises the information related to the second user image of the second user so as to be added to the review management information in order to be sent to the terminal device.

20. A control method for an information providing system, the information providing system comprising:
a server device that is communicably connected to an external server device, the external server device accumulating review management information that comprises review information that indicates a review of a piece of content by a first user and first identification information that corresponds to the first user, associating and storing the first identification information and history information that indicates a service usage history of the first user, and providing a first service that comprises a browsing service that makes the review of the piece of content by the first user browsable, the server device providing a second service to each second user; and
a terminal device that the second user operates,
the control method comprising:
in the server device,
retrieving, upon receiving a request from the terminal device of the second user, the first identification information corresponding to second identification information of the second user from an identification information storing unit that associates and stores first identification information corresponding to a user and second identification information corresponding to the same user,
acquiring, using the retrieved first identification information, review management information regarding, from among pieces of content managed by the external server device, at least one of a piece of content based on a first service usage history of the second user in the external server device and a piece of content based on attribute information of the piece of content, and
sending the acquired review management information to the terminal device; and
in the terminal device,
receiving the review management information from the server device, and
controlling a screen display of the terminal device based on the review management information received from the server device.
